(19) United States
(12) Patent Application Publication
(10) Pub. No.: US 2024/0395014 A1
(43) Pub. Date: Nov. 28, 2024

(54) OBJECT RECOGNITION MODEL UPDATING METHOD AND APPARATUS, ELECTRONIC DEVICE, STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Hui GUO, Shenzhen (CN)

(73) Assignee: TENCENT TECHNOLOGY (SHENZHEN) COMPANY LIMITED, Shenzhen (CN)

(21) Appl. No.: 18/792,108

(22) Filed: Aug. 1, 2024

Related U.S. Application Data
(63) Continuation of application No. PCT/CN2023/129301, filed on Nov. 2, 2023.

(30) Foreign Application Priority Data
Dec. 26, 2022 (CN) 202211678065.2

(51) Int. Cl. G06V 10/762; G06V 10/74

(52) U.S. Cl. CPC G06V 10/762; G06V 10/761

(57) ABSTRACT

An object recognition model updating method includes: obtaining a first object recognition model through training based on first training sample sets of first object recognition tasks, wherein the first training sample sets include first image samples of first objects of first categories in the first object recognition tasks; determining a first category center parameter of the first object recognition model based on first sample features of the first image samples; obtaining a second training sample set of a second object recognition task including second image samples of second objects of second categories in the second object recognition task; determining a second category center parameter based on the first sample features and second sample features of the second image samples; and updating the first category center parameter to the second category center parameter, to obtain a second object recognition model.

### CROSS-REFERENCE TO RELATED APPLICATIONS

This application is a continuation application of International Application No. PCT/CN2023/129301 filed on Nov. 2, 2023, which claims priority to Chinese Patent Application No. 202211678065.2, filed with the China National Intellectual Property Administration on Dec. 26, 2022, the disclosures of each being incorporated by reference herein in their entireties.

### FIELD

The disclosure relates to the field of artificial intelligence technologies, and in particular, to an object recognition model updating method and apparatus, an electronic device, a computer-readable storage medium, and a computer program product.

### BACKGROUND

Artificial Intelligence (AI) studies design principles and implementation methods of various intelligent machines, and the machines may have functions of perception, reasoning, and decision-making. Artificial intelligence technologies relate to a wide range of fields, such as natural language processing and machine learning or deep learning. With the development of new technologies, artificial intelligence will increasingly be applied to more fields and will play an increasingly important role.

Object recognition (for example, recognition on a game character in a game image) is also an important application of artificial intelligence. For example, object recognition for an object recognition task (for example, recognition on game characters of various categories in a game) may be implemented through an object recognition model. To add to the object recognition model a capability of recognizing a new object recognition task, the original object recognition model may be re-trained by using a training sample of the new object recognition task. Such implementations may have low efficiency however. In addition, the training sample of the new object recognition task may need to be re-trained, and a recognition effect of an original object recognition task may be affected.

### SUMMARY

Provided are an object recognition model updating method and apparatus, an electronic device, a computer-readable storage medium, and a computer program product, capable of recognizing a new object recognition task for an object recognition model.

According to some embodiment, an object recognition model updating method, applied to an electronic device, includes: obtaining a first object recognition model through training based on one or more first training sample sets of one or more first object recognition tasks, wherein the one or more first training sample sets include one or more first image samples of a first plurality of objects of a first plurality of categories in the one or more first object recognition tasks; determining a first category center parameter of the first object recognition model based on a first plurality of sample features of the one or more first image samples; obtaining a second training sample set of a second object recognition task including one or more second image samples of a second plurality of objects of a second plurality of categories in the second object recognition task; determining a second category center parameter based on the first plurality of sample features and a second plurality of sample features of the one or more second image samples; and updating the first category center parameter to the second category center parameter, to obtain a second object recognition model, wherein the second object recognition model is configured to recognize, based on the second category center parameter, a second category to which a third object to be recognized belongs, and wherein the second category includes one from among the second plurality of categories and the first plurality of categories.

According to some embodiments, an object recognition model updating apparatus includes: at least one memory configured to store computer program code; and at least one processor configured to read the program code and operate as instructed by the program code, the program code including: first obtaining code configured to cause at least one of the at least one processor to obtain a first object recognition model through training based on one or more first training sample sets of one or more first object recognition tasks, wherein the one or more first training sample sets include one or more first image samples of a first plurality of objects of a first plurality of categories in the one or more first object recognition tasks; second obtaining code configured to configured to cause at least one of the at least one processor to determine a first category center parameter of the first object recognition model based on a first plurality of sample features of the one or more first image samples; third obtaining code configured to configured to cause at least one of the at least one processor to obtain a second training sample set of a second object recognition task including one or more second image samples of a second plurality of objects of a second plurality of categories in the second object recognition task; first determining code configured to configured to cause at least one of the at least one processor to determine a second category center parameter based on the first plurality of sample features and a second plurality of sample features of the one or more second image samples; and first updating code configured to configured to cause at least one of the at least one processor to update the first category center parameter to the second category center parameter, to obtain a second object recognition model, wherein the second object recognition model is configured to recognize, based on the second category center parameter, a second category to which a third object to be recognized belongs, and wherein the second category includes one from among the second plurality of categories and the first plurality of categories.

According to some embodiments, a non-transitory computer-readable storage medium, storing computer code which, when executed by at least one processor, causes the at least one processor to at least: first obtaining code configured to cause at least one of the at least one processor to obtain a first object recognition model through training based on one or more first training sample sets of one or more first object recognition tasks, wherein the one or more first training sample sets include one or more first image samples of a first plurality of objects of a first plurality of categories in the one or more first object recognition tasks; obtain a first category center parameter of the first object recognition model based on a first plurality of sample features of the one or more first image samples; obtain a second training sample set of a second object recognition task including one or more second image samples of a second plurality of objects of a second plurality of categories in the second object recognition task; determine a second category center parameter based on the first plurality of sample features and a second plurality of sample features of the one or more second image samples; and update the first category center parameter to the second category center parameter, to obtain a second object recognition model, wherein the second object recognition model is configured to recognize, based on the second category center parameter, a second category to which a third object to be recognized belongs, and wherein the second category includes one from among the second plurality of categories and the first plurality of categories.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic architectural diagram of an object recognition model updating system 100 according to some embodiments;

FIG. 2 is a schematic flowchart of an object recognition model updating method according to some embodiments;

FIG. 3 is a schematic flowchart of an object recognition model updating method according to some embodiments;

FIG. 4 is a schematic structural diagram of an object recognition model according to some embodiments;

FIG. 5 is a schematic flowchart of an object recognition model updating method according to some embodiments;

FIG. 6 is a schematic diagram of updating an object recognition model according to some embodiments;

FIG. 7 is a schematic flowchart of an object recognition model updating method according to some embodiments;

FIG. 8 is a schematic flowchart of an object recognition model updating method according to some embodiments;

FIG. 9A is a schematic diagram of application of an object recognition model according to some embodiments;

FIG. 9B is a schematic diagram of application of an object recognition model according to some embodiments;

FIG. 10 is a schematic structural diagram of an object recognition model updating apparatus according to some embodiments; and

FIG. 11 is a schematic structural diagram of an electronic device 500 implementing an object recognition model updating method according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following descriptions, the included term “first/second/third” is merely intended to distinguish similar objects but does not necessarily indicate an order of an object. It may be understood that “first/second/third” is interchangeable in terms of an order or sequence if permitted, and the embodiments described herein may be implemented in a sequence in addition to the sequence shown or described.

Unless otherwise defined, meanings of technical and scientific terms are the same as those understood by a person skilled in the art. Terms used are merely intended to describe some embodiments and are not intended to limit the disclosure.

Before some embodiments are further described in detail, nouns and terms involved in some embodiments are described. The nouns and terms provided in some embodiments are applicable to the following explanations.

(1) Client: It is an application run on a terminal and configured to provide various services, for example, a client support object recognition processing.

(2) “In response to” is configured for representing a condition or status on which one or more operations to be performed depend. When the condition or status is met, the one or more operations may be performed immediately or after a set delay. Unless otherwise indicated, there is no chronological order between the plurality of to-be-performed operations.

Some embodiments provide an object recognition model updating method and apparatus, an electronic device, a computer-readable storage medium, and a computer program product, to improve implementation efficiency of adding a capability of recognizing a new object recognition task to an object recognition model, and ensure a recognition effect of the object recognition model. Descriptions are separately provided below.

When a product or technology is applied to some embodiments, a user's permission or consent should be obtained, and acquisition, use, and processing of the relevant data should to comply with the relevant laws and standards of the relevant countries and regions.

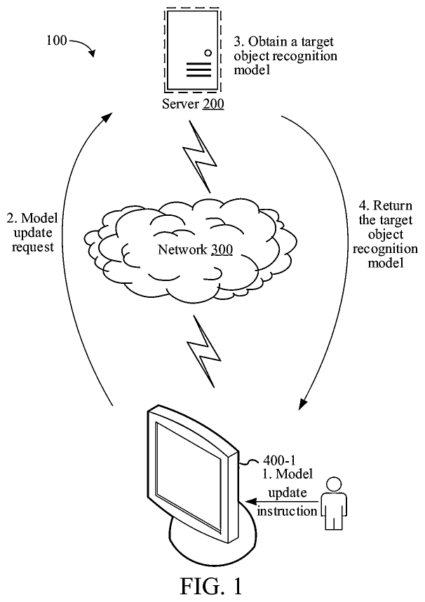

An object recognition model updating system provided in some embodiments is described below. FIG. 1 is a schematic architectural diagram of an object recognition model updating system 100 according to some embodiments. To support an exemplary application, terminals (where a terminal 400-1 is shown as an example) is connected to a server 200 via a network 300. The network 300 may be a wide area network, a local area network, or a combination of thereof. Data transmission is implemented over a wireless or wired link.

The terminal (for example, the terminal 400-1) is configured to send a model update request for an object recognition model to the server 200 in response to a model update instruction for the object recognition model. The server 200 is configured to: receive the model update request sent by the terminal; obtain an object recognition model in response to the model update request, the object recognition model being configured to recognize objects of a plurality of categories in at least one object recognition task, the object recognition model being obtained through training based on training sample sets of the object recognition tasks, and each of the training sample sets of each of the object recognition tasks including image samples of the objects of the various categories in the object recognition task; obtain a category center parameter of the object recognition model, the category center parameter being determined based on sample features of the image samples in each of the training sample sets; obtain a target training sample set of a new object recognition task, the target training sample set including image samples of objects of a plurality of categories in the new object recognition task; determine a target category center parameter based on a sample feature of each image sample in each training sample set and a sample feature of each image sample in the target training sample set; and update the category center parameter of the object recognition model to the target category center parameter, to obtain a target object recognition model. The target object recognition model supporting the at least one object recognition task and the new object recognition task may be obtained.

In some embodiments, based on obtaining the target object recognition model, the server 200 may actively send the target object recognition model to the terminal, for the terminal to use during object recognition processing. The terminal may actively obtain the target object recognition model from the server 200 when performing object recognition processing. The server 200 may send the target object recognition model to the terminal when the terminal actively obtains the target object recognition model.

For example, the terminal (for example, terminal 400-1) may be configured with a client supporting object recognition processing. When object recognition processing is performed, a user may trigger an action recognition instruction on the terminal (for example, the terminal 400-1) through the client. The terminal obtains the target object recognition model from the server 200 in response to the action recognition instruction; obtains an object image of a to-be-recognized object; and performs object recognition on the object image through the target object recognition model based on the target category center parameter, to obtain a target category to which a to-be-recognized object belongs, the target category being one of the following categories: the plurality of categories in the new object recognition task or the plurality of categories in the at least one object recognition task.

In some embodiments, the object recognition model updating method provided in some embodiments may be implemented by various electronic devices, for example, may be separately implemented by the terminal, may be separately implemented by the server, or may be implemented by the terminal and the server in cooperation. The object recognition model updating method provided in some embodiments is applicable to various scenarios, including but not limited to the cloud technology, artificial intelligence, intelligent transportation, assisted driving, games, audio and video, images, and the like.

In some embodiments, the electronic device implementing the object recognition model updating method provided in some embodiments may be a terminal device or server of any type. The server (for example, the server 200) may be an independent physical server, or may be a server cluster including a plurality of physical servers or a distributed system. The terminal (for example, the terminal 400-1) may be a smartphone, a tablet computer, a notebook computer, a desktop computer, a smart voice interaction device (for example, a smart speaker), a smart home appliance (for example, a smart television), a smartwatch, a vehicle-mounted terminal, a wearable device, a virtual reality (VR) device, or the like, but is not limited thereto. The terminal and the server may be directly or indirectly connected in a wired or wireless communication manner.

In some embodiments, the object recognition model updating method provided in some embodiments may be implemented by using a cloud technology. The cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool. A cloud computing technology becomes an important support. A background service of a technical network system may use a large amount of computing and storage resources. For example, the server (for example, the server 200) may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform.

In some embodiments, a plurality of servers may be formed into a blockchain, and the server is a node on the blockchain. Information connections may exist between nodes on the blockchain, and information transmission may be performed between the nodes via the information connections. Data (for example, an object recognition model, a target object recognition model, a training sample set, and a target training sample set) related to the object recognition model updating method provided in some embodiments may be stored on the blockchain.

In some embodiments, the terminal or the server may implement object recognition model updating method provided in some embodiments by running a computer program, for example, the computer program may be a native program or a software module in an operating system; a native application (APP), for example, an application that is to be installed in the operating system for running; a mini program, for example, a program that can be run simply by downloading the program into a browser environment; or may be a mini program that can be embedded into any APP. Based on the above, the computer program may be an application, module, or plug-in in any form.

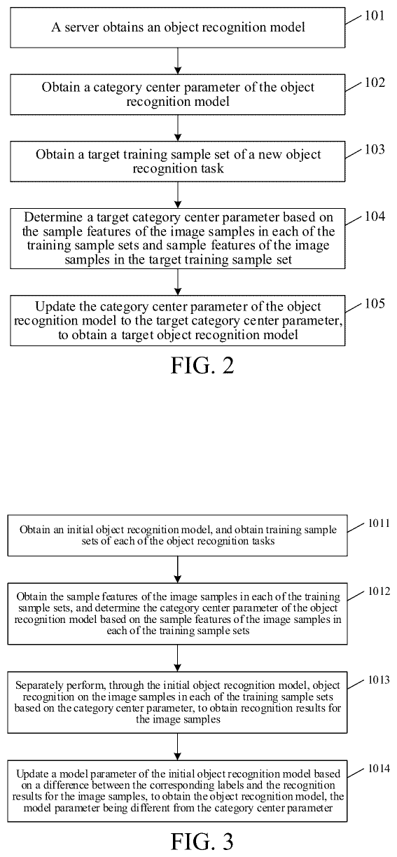

The object recognition model updating method provided in some embodiments is described below. In some embodiments, the object recognition model updating method provided in some embodiments may be implemented by various electronic devices, for example, may be separately implemented by the terminal, may be separately implemented by the server, or may be implemented by the terminal and the server in cooperation. Using server implementation as an example, FIG. 2 is a schematic flowchart of an object recognition model updating method according to some embodiments. The object recognition model updating method provided in some embodiments includes the following operations:

Operation 101. A server obtains an object recognition model.

The object recognition model is configured to recognize objects of a plurality of categories in at least one object recognition task. The object recognition model is obtained through training based on training sample sets of the object recognition tasks. Each of the training sample sets of each of the object recognition tasks includes image samples of the objects of the various categories in the object recognition task.

A user may trigger a model update instruction for the object recognition model through a client (for example, a client supporting object recognition processing) disposed in a terminal, and the terminal may send a model update request for the object recognition model to the server in response to the model update instruction. When receiving the model update request sent by the terminal, the server obtains, in response to the model update request, an object recognition model on which pre-training is completed. The object recognition model may be configured to recognize the objects of the plurality of categories in the at least one object recognition task. The object recognition model is obtained through training based on the training sample sets of the object recognition tasks (including image samples of the objects of the various categories in the object recognition task). The object recognition task may be a recognition task for an object of a category in an image of a target service. For example, the target service may be a game service, and different object recognition tasks may be object recognition tasks of different games (for example, a game 1 and a game 2). The target service may be a video service, and different object recognition tasks may be object recognition tasks of different videos (for example, a movie 1 and a movie 2), or the like.

In some embodiments, FIG. 3 is a schematic flowchart of an object recognition model updating method according to some embodiments. FIG. 3 illustrates that operation 101 shown in FIG. 2 may be implemented by performing operation 1011 to operation 1014. Operation 1011: Obtain an initial object recognition model, and obtain the training sample sets of the object recognition tasks, the image samples in each of the training sample sets being annotated with labels. Operation 1012: Obtain the sample features of the image samples in each of the training sample sets, and determine the category center parameter of the object recognition model based on the sample features of the image samples in each of the training sample sets. Operation 1013: Separately perform, through the initial object recognition model, object recognition on the image samples in each of the training sample sets based on the category center parameter, to obtain recognition results for the image samples. Operation 1014: Update a model parameter of the initial object recognition model based on a difference between the labels and the recognition results for the image samples, to obtain the object recognition model, the model parameter being different from the category center parameter.

In operation 1011, the image samples are object images of objects of the various categories in each of the object recognition tasks. Sample sizes of the image samples in each of the training sample sets may be the same, and balancing of the sample sizes can ensure that each of the object recognition tasks obtains an equal learning opportunity, thereby obtaining the object recognition model with balanced recognition precision for the object recognition tasks. In operation 1012, the image samples in each of the training sample sets may be extracted to obtain sample features of each of the image samples. For example, embedding feature extraction may be performed on the image samples to obtain the sample features. The sample features of the image samples in the training sample sets may be clustered through a target quantity of cluster centers to obtain a target quantity of feature clusters, and sample features corresponding to the cluster centers of the feature clusters may be combined to obtain the category center parameter of the object recognition model. In operation 1013, the category center parameter calculated in operation 1012 may be used as a category center parameter of the initial object recognition model, and the initial object recognition model may be invoked based on the category center parameter to separately perform object recognition on the image samples in each of the training sample sets, to obtain the recognition results for the image samples. In operation 1014, for each image sample, a value of a loss function of the initial object recognition model is determined based on a difference between a recognition result for the image sample and the label. An error signal of the initial object recognition model is determined based on the loss function when the value of the loss function is greater than a preset threshold. The error signal may be backpropagated in the initial object recognition model, and the model parameters of layers in the initial object recognition model are updated during propagation, to train the initial object recognition model to obtain the object recognition model. The model parameter updated in operation 1014 does not include the category center parameter.

According to some embodiments, the initial object recognition model is trained through the training sample sets to obtain the object recognition model. The object recognition model has the category center parameter determined based on the sample featured of the image sampled. The category center parameter is obtained without performing model training. When a capability of recognizing a new object recognition task is to be added to the object recognition model, this may be implemented by updating the category center parameter, and re-training the object recognition model may be avoided, and the following may be achieved: (1) Implementation efficiency of adding a capability of recognizing a new object recognition task to the object recognition model is improved. (2) While the capability of recognizing the new object recognition task is added to the object recognition model, a recognition effect of an original object recognition task of the object recognition model is not affected.

In some embodiments, the server may obtain the training sample sets of the object recognition tasks in the following manner: performing the following operations for each of the object recognition tasks: obtaining an object video of the object recognition task, the object video including a plurality of frames of video images; determining a plurality of frames of target video images in the plurality of frames of video images, each of the target video images including the objects of the plurality of categories in the object recognition task; selecting, for the objects of the various categories in the object recognition task, a target quantity of first video images including the objects from the plurality of frames of target video images, and using the first video images as the image samples of the objects of the corresponding categories; and constructing the training sample sets of the object recognition tasks based on the image samples of the objects of the various categories in the object recognition task.

An object video of the object recognition task may be obtained. The object video includes a plurality of frames of video images, and object detection may be performed on each frame of video image, to determine a plurality of frames of target video images in the plurality of frames of video images, each of the target video images including the objects of the plurality of categories in the object recognition task. The object detection process may be implemented through an object detection model. For example, the object detection model may be a target detector (You Only Look Once, YOLO) trained based on a contextual common objects in context (COCO) dataset, or may be an object detector pre-trained based on service data (for example, video images of each frame in a game video). For the objects of the various categories in the object recognition task, the target quantity of first video images including the objects of the categories are selected from the plurality of frames of target video images, and the first video images are used as the image samples of the objects of the categories. The training sample sets of the object recognition tasks may be constructed by combining the image samples of the objects of the various categories in the object recognition task.

In some embodiments, the initial object recognition model includes a feature extraction layer. The server may obtain the sample features of the image samples of the training sample sets in the following manner: separately performing, through the feature extraction layer, feature extraction on the image samples in each of the training sample sets, to obtain the sample features of the image samples. Based on updating the model parameter of the initial object recognition model, the server may update the category center parameter of the object recognition model in the following manner: separately performing feature extraction on the image samples in each of the training sample sets through the feature extraction layer updated by using the model parameter, to obtain new sample features of the image samples; determining a new category center parameter of the object recognition model based on the new sample features of the image samples in each of the training sample sets; and updating the category center parameter of the object recognition model to the new category center parameter.

The category center parameter of the object recognition model may be generated based on the sample features extracted through the feature extraction layer of the initial object recognition model. The model parameter of the feature extraction layer of the initial object recognition model is updated in a process of training the initial object recognition model. Therefore, the category center parameter of the object recognition model may be updated. Feature extraction may be separately performed on the image samples in each of the training sample sets through the feature extraction layer updated by using the model parameter, to obtain new sample feature of the image samples, and a new category center parameter of the object recognition model may be determined based on the new sample features of the image samples in each of the training sample sets, and the category center parameter of the object recognition model may be updated to the new category center parameter. The category center parameter obtained in operation 102 may be the new category center parameter. According to some embodiments, based on training on the initial object recognition model being completed, the new category center parameter can be determined based on the feature extraction layer updated by using the model parameter, thereby improving accuracy of object recognition through the object recognition model.

In some embodiments, a plurality of image samples of the objects of the various categories in each of the training sample sets exist, and the server may use the following manner to determine the category center parameter of the object recognition model based on the sample features of the image samples in each of the training sample sets: determining a plurality of sample features corresponding to the objects of the various categories from the sample features of the image samples in each of the training sample sets; clustering, for the plurality of sample features corresponding to the objects of the various categories, the plurality of sample features based on a target quantity of cluster centers, to obtain a target quantity of sample feature clusters; and generating the category center parameter of the object recognition model based on target sample features corresponding to the cluster centers of the sample feature clusters.

The training sample set includes image samples of objects of various categories in the object recognition task. Therefore, feature extraction may be performed on the image samples of the objects of the various categories to obtain the sample features of the image samples of the objects of the various categories. The sample features of the image samples of the objects of the various categories are a plurality of sample features corresponding to the objects of the various categories. For the plurality of sample features corresponding to the objects of the various categories, clustering processing based on the target quantity of cluster centers may be performed, to the target quantity of sample feature clusters. For example, clustering processing may be implemented by using a k-means algorithm. The target quantity is represented by k in the k-means algorithm, and may be preset or determined by using a contour coefficient method or an elbow method. The target sample features corresponding to the cluster centers of the sample feature clusters may be combined, to obtain the category center parameter of the object recognition model. For example, when the target sample features of the target quantity are combined, the target sample features of the target quantity may be spliced to obtain the category center parameters. Clustering processing is performed on the sample features of the samples in the training sample set to generate the category center parameter. This can ensure accuracy of the category center parameter, and make the category center parameter more representative of the plurality of categories in the object recognition task, thereby improving precision of object recognition by the model.

In some embodiments, the category center parameter includes a plurality of subcategory center parameters, and the subcategory center parameters are in a one-to-one correspondence with category centers of the various categories in the at least one object recognition task, for example, one subcategory center parameter corresponds to one category center. Each category includes at least one category center. The category center is configured for representing expression forms of an object of the category. Different category centers correspond to different expression forms. For example, in a game object recognition task, the category center may be at least one game object archetype of a game object to which a category belongs. The game object archetypes are different expression forms of the game object. For example, standard object styles of the game object when the game object casts a game skill 1, casts a game skill 2, casts a game skill 3, stands, and walks may be considered as five game object archetypes of the game object. The server may use the following manner to separately perform, through the initial object recognition model, object recognition on the image samples in each of the training sample sets based on the category center parameter, to obtain recognition results for the image samples: separately performing feature extraction on the image samples in each of the training sample sets, to obtain the sample features of the image samples; performing first object recognition on the sample features of the image samples in each of the training sample sets based on the subcategory center parameters, to obtain probabilities that objects in the image samples belong to the category centers; and determining, for the image samples and based on the probabilities that the objects in the image samples belong to the category centers, categories to which the objects in the image samples belong, and using the categories to which the objects in the image samples belong as the recognition results.

In some embodiments, the server may use the following manner to separately performing feature extraction on the image samples in each of the training sample sets, to obtain the sample features of the image samples: separately performing convolution processing on the image samples in each of the training sample sets, to obtain convolution features of the image samples; separately performing pooling processing on the convolution features of the image samples, to obtain pooling features of the image samples; performing embedding feature extraction processing on the pooling features of the image samples, to obtain embedding features of the image samples; performing feature mapping processing on the embedding features of the image samples, to obtain mapping features of the image samples; and performing normalization processing on the pooling features of the image samples, to obtain the sample features of the image samples. The convolution processing may be implemented based on preset convolution processing parameters (such as a size of a convolution kernel, a quantity of convolution kernels, and a step size). The pooling processing may be implemented based on preset pooling processing parameters (such as a pooling window size and a step size). The embedding feature extraction processing may be implemented through a pre-trained embedding feature extraction network (for example, an embedding network).

According to some embodiments, each subcategory center parameter may be the target sample feature corresponding to the cluster center of the sample feature cluster. Therefore, during first object recognition, the following processing may be separately performed for each subcategory center parameter: determining a similarity (for example, a cosine similarity) or a distance (for example, a Euclidean distance) between a target sample feature corresponding to the subcategory center parameter and a sample feature of each of the image samples, and using the similarity or the distance as a probability that an object in each of the image sampled belongs to a category center corresponding to the subcategory center parameter. The following processing may be performed for each of the image samples: determining categories to which the objects in the image samples belong based on the probability that the object in the image sample belongs to the category center. For example, a category included in the category center corresponding to a maximum probability (for example, a maximum similarity or a maximum distance) may be determined as the category to which the object in the image sample belongs. Recognition of the category to which the object in the image sample belongs may be implemented by using the category center parameter.

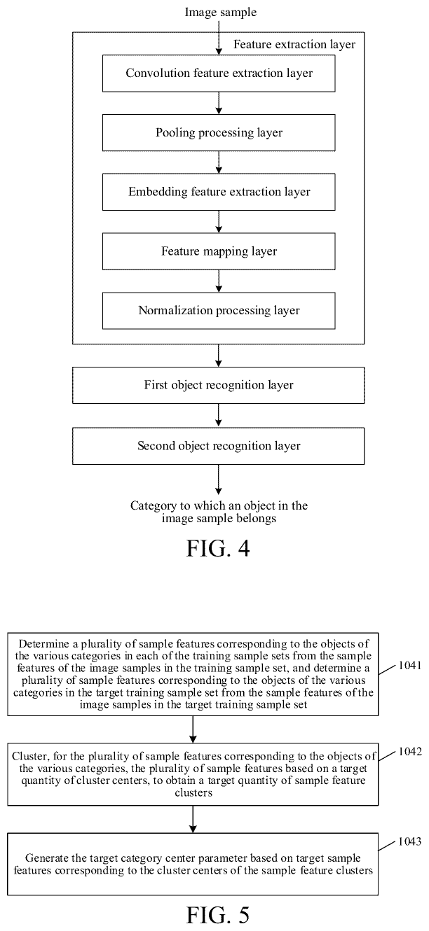

For example, FIG. 4 is a schematic structural diagram of an object recognition model according to some embodiments. An initial object recognition model includes a feature extraction layer, a first object recognition layer, and a second object recognition layer. Correspondingly, the server may use the following manner to separately perform, through the initial object recognition model, object recognition on the image samples in each of the training sample sets based on the category center parameter, to obtain recognition results for the image samples: separately performing, through the feature extraction layer, feature extraction on the image samples in each of the training sample sets, to obtain the sample features of the image samples; performing, through the first object recognition layer, first object recognition on the sample features of the image samples in each of the training sample sets based on the subcategory center parameters, to obtain probabilities that objects in the image samples belong to the category centers; and determining, for the image samples and based on the probabilities that the objects in the image samples belong to the category centers and through the second object recognition layer, categories to which the objects in the image samples belong, and using the categories to which the objects in the image samples belong as the recognition results.

Still refer to FIG. 4. The feature extraction layer includes: a convolution feature extraction layer, a pooling processing layer, an embedding feature extraction layer, a feature mapping layer, and a normalization processing layer. Convolution processing may be separately performed on the image samples in each of the training sample sets through the convolution feature extraction layer, to obtain convolution features of the image samples; pooling processing may be separately performed on the convolution features of the image samples through the pooling processing layer, to obtain pooling features of the image samples; embedding feature extraction processing may be performed on the pooling features of the image samples through the embedding feature extraction layer, to obtain embedding features of the image samples; feature mapping processing may be performed on the embedding features of the image samples through the feature mapping layer, to obtain mapping features of the image samples; and normalization processing may be performed on the pooling features of the image samples through the normalization processing layer, to obtain the sample features of the image samples.

In some embodiments, M object recognition tasks exist, the initial object recognition model may be trained separately based on the training sample sets of the object recognition tasks, to obtain the object recognition model. An initial object recognition model may be obtained, and training sample sets of each of the object recognition tasks may be obtained; the initial object recognition model may be trained based on a training sample set of the 1^{st} object recognition task, to obtain an intermediate object recognition model of the 1^{st} object recognition task; an intermediate object recognition model of an (i−1)^{th} object recognition task may be trained by using a training sample set of an i^{th} object recognition task, to obtain an intermediate object recognition model of the i^{th} object recognition task; and i object recognition tasks may be traversed to obtain an intermediate object recognition model of an M^{th} object recognition task, and the intermediate object recognition model of the M^{th} object recognition task may be used as the object recognition model, where M and i are integers greater than 1, and i is less than or equal to M.

Operation 102: Obtain a category center parameter of the object recognition model.

The category center parameter is determined based on sample features of the image samples in each of the training sample sets.

The category center parameter may be generated based on the sample features extracted through the feature extraction layer of the object recognition model for the image samples in the training sample sets. A plurality of sample features corresponding to the objects of the various categories may be determined from the sample features of the image samples in each of the training sample sets; for the plurality of sample features corresponding to the objects of the various categories, the plurality of sample features may be clustered based on a target quantity of cluster centers, to obtain a target quantity of sample feature clusters; and the category center parameter of the object recognition model may be generated based on target sample features corresponding to the cluster centers of the sample feature clusters. The training sample set includes image samples of objects of various categories in the object recognition task. Therefore, feature extraction may be performed on the image samples of the objects of the various categories to obtain the sample features of the image samples of the objects of the various categories. The sample features of the image samples of the objects of the various categories are a plurality of sample features corresponding to the objects of the various categories. For the plurality of sample features corresponding to the objects of the various categories, clustering processing based on the target quantity of cluster centers may be performed, to the target quantity of sample feature clusters. For example, clustering processing may be implemented by using a k-means algorithm. The target quantity is represented by k in the k-means algorithm, and may be preset or determined by using a contour coefficient method or an elbow method. The target sample features corresponding to the cluster centers of the sample feature clusters may be combined, to obtain the category center parameter of the object recognition model. For example, when the target sample features of the target quantity are combined, the target sample features of the target quantity may be spliced to obtain the category center parameters.

In some embodiments, the category center parameter of the object recognition model includes a plurality of subcategory center parameters, and the subcategory center parameters are in a one-to-one correspondence with category centers of the various categories in the at least one object recognition task. For example, the category center parameter is configured for indicating a category center of each of the categories in the at least one object recognition task. When the to-be-recognized object is recognized through the object recognition model by using the category center parameter, probabilities that the to-be-recognized object belongs to the various categories in the at least one object recognition task may be obtained.

In some embodiments, the category center parameter of the object recognition model may include task category center parameters of the object recognition tasks. Taking the target recognition task in the at least one object recognition task as an example, the task category center parameter of the target recognition task includes a plurality of subtask category center parameters. The plurality of subtask category center parameters include a first subtask category center parameter and a second subtask category center parameter. The first subtask category center parameter is in a one-to-one correspondence with the category centers of the various categories in the target recognition task. The second subtask category center parameter corresponds to recognition tasks other than the target recognition task in the at least one object recognition task. The task category center parameter of the target recognition task may be configured for indicating: category centers of the various categories in the target recognition task, and other category centers of other recognition tasks (where the category centers of the various categories in other recognition tasks are collectively referred to as other category centers herein, and are not distinguished). When recognition is performed on the to-be-recognized object through the object recognition model, recognition may be separately performed by using the task category center parameters of the object recognition tasks. However, when the to-be-recognized object is to be recognized, which object recognition task (for example, the target recognition task) is set in advance, recognition is performed directly by using a task category center parameter of the set object recognition task. Taking the task category center parameter of the target recognition task as an example, when the to-be-recognized object is recognized through the object recognition model by using the task category center parameter, probabilities that the to-be-recognized object belongs to the various categories in the target recognition task and probabilities that the to-be-recognized object belongs to other categories in other recognition tasks may be obtained.

Operation 103: Obtain a target training sample set of a new object recognition task.

The target training sample set includes image samples of objects of a plurality of categories in the new object recognition task. When the target training sample set is constructed, a sample size of image samples of objects of each category in the target training sample set and a sample size of image samples of the objects of the various categories in the training sample set may be the same or different. The new object recognition task is different from any one of the at least one object recognition task.

A new object video of the new object recognition task may be obtained. The new object video includes a plurality of frames of video images, and object detection may be performed on each frame of video image, to determine a plurality of frames of target video images in the plurality of frames of video images, each of the target video images including the objects of the plurality of categories in the new object recognition task. The object detection process may be implemented through an object detection model. For example, the object detection model may be a yolov3 detector trained based on a coco dataset, or may be an object detector pre-trained based on service data (for example, a video image at each frame in a game video). For the objects of the various categories in the new object recognition task, a target quantity of second video images including the objects of the categories are selected from the plurality of frames of target video images, and the second video images are used as the image samples of the objects of the categories. The target training sample sets of the new object recognition tasks may be constructed by combining the image samples of the objects of the various categories in the new object recognition task.

Operation 104: Determine a target category center parameter based on the sample features of the image samples in each of the training sample sets and sample features of the image samples in the target training sample set.

Based on the target training sample set of the new object recognition task being obtained, a target category center parameter of the new object recognition task may be determined. The target category center parameter may be generated based on the sample features of the image samples in the target training sample set and the sample features of the image samples in each of the training sample sets of the new object recognition task. In some embodiments, a plurality of image samples of the objects of the various categories in each of the training sample sets exist, and a plurality of image samples of objects of various categories in the target training sample set exist. FIG. 5 is a schematic flowchart of an object recognition model updating method according to some embodiments. FIG. 5 illustrates that operation 104 shown in FIG. 2 may be implemented by performing operation 1041 to operation 1043. Operation 1041: Determine a plurality of sample features corresponding to the objects of the various categories in each of the training sample sets from the sample features of the image samples in the training sample set, and determine a plurality of sample features corresponding to the objects of the various categories in the target training sample set from the sample features of the image samples in the target training sample set. Operation 1042: Cluster, for the plurality of sample features corresponding to the objects of the various categories, the plurality of sample features based on a target quantity of cluster centers, to obtain a target quantity of sample feature clusters. Operation 1043: Generate the target category center parameter based on target sample features corresponding to the cluster centers of the sample feature clusters.

In operation 1041, the sample features of the image samples may be obtained by performing feature extraction on the image samples through a feature extraction layer of the object recognition model. In operation 1042, when the plurality of sample features are clustered based on the target quantity of cluster centers, a clustering algorithm may be used to implement the clustering processing. For example, clustering processing may be implemented by using a k-means algorithm. The target quantity is represented by k in the k-means algorithm, and may be preset or determined by using a contour coefficient method or an elbow method. In operation 1043, the target sample features corresponding to the cluster centers of the sample feature clusters are combined, to obtain the target category center parameter. A process of combining may be to splice the target sample features, to obtain the target category center parameter. The target category center parameter includes a plurality of target subcategory center parameters, the target subcategory center parameters are in a one-to-one correspondence with category centers of various categories in a target object recognition task, and the target object recognition task includes the at least one object recognition task and the new object recognition task. Each target subcategory center parameter may be the target sample feature corresponding to the cluster center of the sample feature cluster obtained through clustering. Clustering processing may be performed on the sample features of the samples in the training sample set and the target training sample set to generate the target category center parameter. This may ensure accuracy of the target category center parameter, and may make the target category center parameter more representative of the plurality of categories in the target object recognition task, thereby improving precision of object recognition by the model.

In some embodiments, the server may use the following manner to determine a target category center parameter based on a sample feature of each image sample in each training sample set and a sample feature of each image sample in the target training sample set: performing the following operations for each of the training sample sets: determining, for the sample features of the image samples in the training sample set, feature similarities between the sample features of the image samples and the sample features of the image samples in the target training sample set; screening, from the training sample set, sample features of the image samples with a feature similarity satisfying a similarity condition, to obtain first training sample sets; and determining the target category center parameter based on the sample features of the image samples in each of the first training sample sets and the sample features of the image samples in the target training sample set.

There may be image samples in the training sample set that are relatively similar to the image samples in the target training sample set of the new object recognition task. To reduce impact of the similar image samples on precision of recognition of the new object recognition task, processing may be performed as follows: Feature similarities between the sample features of the image samples and the sample features of the image samples in the target training sample set may be determined for the sample features of the image samples in the training sample set. The sample features of the image samples with the feature similarities satisfying a similarity condition (for example, image samples with feature similarities reaching a similarity threshold (which may be preset) or image samples with a target quantity of top (which may be preset) feature similarities in descending order) may be screened out from the training sample sets, to obtain the first training sample sets. The target category center parameter may be determined based on the sample features of the image samples in each of the first training sample sets and the sample features of the image samples in the target training sample set. A plurality of sample features corresponding to the objects of the various categories in each of the first training sample sets may be determined from the sample features of the image samples in the first training sample set, and a plurality of sample features corresponding to the objects of the various categories in the target training sample set may be determined from the sample features of the image samples in the target training sample set. For the plurality of sample features corresponding to the objects of the various categories, the plurality of sample features may be clustered based on a target quantity of cluster centers, to obtain a target quantity of sample feature clusters. The target category center parameter may be generated based on target sample features corresponding to the cluster centers of the sample feature clusters. Image samples with similarities satisfying the similarity condition in the training sample set and the target training sample set may be screened out, the impact of the similar image samples on the precision of recognition of the new object recognition task may be reduced, and the precision of recognition of the new object recognition task may be improved based on the target category center parameter.

Operation 105: Update the category center parameter of the object recognition model to the target category center parameter, to obtain a target object recognition model.

The target object recognition model is configured to recognize, based on the target category center parameter, a target category to which a to-be-recognized object belongs, where the target category is one of the following categories: the plurality of categories in the new object recognition task or the plurality of categories in the at least one object recognition task.

In some embodiments, when the category center parameter is configured for indicating the category centers of the categories in the at least one object recognition task, the target category center parameter may also be configured for indicating the category centers of the categories in the at least one object recognition task and the new object recognition task. When the to-be-recognized object is recognized through the target object recognition model by using the target category center parameter, probabilities that the to-be-recognized object belongs to the various categories in the at least one object recognition task and the various categories in the new object recognition task may be obtained. The category center parameter of the object recognition model may be updated to the target category center parameter, and the target object recognition model may have the capability recognizing the at least one object recognition task, and the capability of recognizing the new object recognition task may be obtained.

In some embodiments, when the category center parameters include the task category center parameters of the object recognition tasks, and the task category center parameter of the target recognition task is configured for indicating: category centers of the various categories in the target recognition task and other category centers of other recognition tasks, the target category center parameter may also be configured for indicating: category centers of the various categories in the new recognition task, and other category centers of other recognition tasks. For example, the target category center parameter may be understood as a task category center parameter of the new object recognition task. When the to-be-recognized object is recognized through the target object recognition model by using the target category center parameter, probabilities that the to-be-recognized object belongs to the various categories in the new object recognition task and probabilities that to-be-recognized object belongs to other object recognition tasks may be obtained. The category center parameter of the object recognition model may be updated to the target category center parameter, and the target object recognition model may have the capability of recognizing the new object recognition task. The target category center parameter may also be added to the category center parameter as the task category center parameter, to update the category center parameter of the object recognition model, and when recognition of the new object recognition task is performed on the to-be-recognized object, the target category center parameter may be invoked from an updated category center parameter for recognition.

In some embodiments, if a new object recognition task (for example, a target new object recognition task) is to be added again, the target category center parameter corresponding to the target new object recognition task may be obtained by performing operation 104 based on the training sample sets and a training sample set of the target new object recognition task. For each new object recognition task, the target category center parameter of the new object recognition task may be obtained based on operation 104. The target object recognition model supporting the new object recognition task and the at least one object recognition task may be obtained based on the category center parameter of the object recognition model being updated to the target category center parameter of the new object recognition task for the target category center parameter of each new object recognition task.

When object recognition is performed, to recognize a new object recognition task to be performed, a target object recognition model may be obtained by updating the category center parameter of the object recognition model to a target category center parameter of a corresponding new object recognition task, to implement object recognition of the new object recognition task. Re-training the object recognition model may be avoided. This may improve the implementation efficiency of adding a capability of recognizing a new object recognition task to the object recognition model. While the capability of recognizing the new object recognition task is added to the object recognition model, a recognition effect of an original object recognition task of the object recognition model is not affected, thereby ensuring the recognition effect of the target object recognition model for the original object recognition task, and improving recognition accuracy of the target object recognition model to which the new object recognition task has been added.

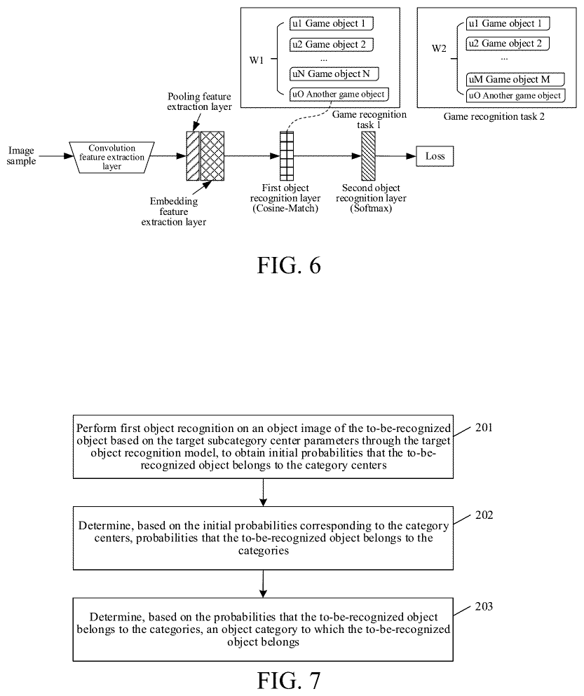

For example, FIG. 6 is a schematic flowchart of an object recognition model updating method according to some embodiments. The object recognition model includes a convolution feature extraction layer (which may be constructed based on a convolutional neural network), a pooling feature extraction layer, an embedding feature extraction layer, a first object recognition layer (cosine-match), and a second object recognition layer (Softmax layer). A model parameter that is to be learned may not be set for the Softmax layer, and a category center parameter w of an object recognition model may be set for the cosine-match layer. As shown in FIG. 6, a newly added object recognition task includes a game recognition task 1 and a game recognition task 2. A category center parameter W1 of the game recognition task 1 is configured for representing: a plurality of category centers [u1 . . . uN] corresponding to categories (game objects) in the game recognition task 1, and a category center uO of another category (game object) in another game recognition task (different from the game recognition task 1). A category center parameter W2 of the game recognition task 2 is configured for representing: a plurality of category centers [u1 . . . uM] corresponding to categories (game objects) in the game recognition task 2, and a category center uO of another category (game object) in another game recognition task (different from the game recognition task 2).

In some embodiments, the target category center parameter includes a plurality of target subcategory center parameters, the target subcategory center parameters are in a one-to-one correspondence with category centers of various categories in a target object recognition task, and the target object recognition task includes the at least one object recognition task and the new object recognition task. FIG. 7 is a schematic flowchart of an object recognition model updating method according to some embodiments. The object recognition model updating method includes: Operation 201: Perform first object recognition on an object image of the to-be-recognized object based on the target subcategory center parameters through the target object recognition model, to obtain initial probabilities that the to-be-recognized object belongs to the category centers. Operation 202: Determine, based on the initial probabilities corresponding to the category centers, probabilities that the to-be-recognized object belongs to the categories. Operation 203: Determine, based on the probabilities that the to-be-recognized object belongs to the categories, an object category to which the to-be-recognized object belongs.

According to some embodiments, each target subcategory center parameter may be the target sample feature corresponding to the cluster center of the sample feature cluster obtained through clustering. Therefore, in operation 201, feature extraction may be performed on the object image of the to-be-recognized object through the target object recognition model to obtain an object image feature, and the following processing may be separately performed on the target subcategory center parameter: determining a similarity (for example, a cosine similarity) or a distance (for example, a Euclidean distance) between a target sample feature corresponding to the target subcategory center parameter and the object image feature of the to-be-recognized object, and using the similarity or the distance as an initial probability that the to-be-recognized object belongs to a category center corresponding to the target subcategory center parameter. In operation 202, the following processing may be separately performed for the categories: determining a maximum initial probability (for example, a maximum similarity or a maximum distance) from initial probabilities corresponding to the category centers of the various categories, and determining the maximum initial probability as a probability that the to-be-recognized object belongs to the category. In operation 203, in some embodiments, the category of the category center corresponding to the maximum probability may be used as the object category to which the to-be-recognized object belongs.

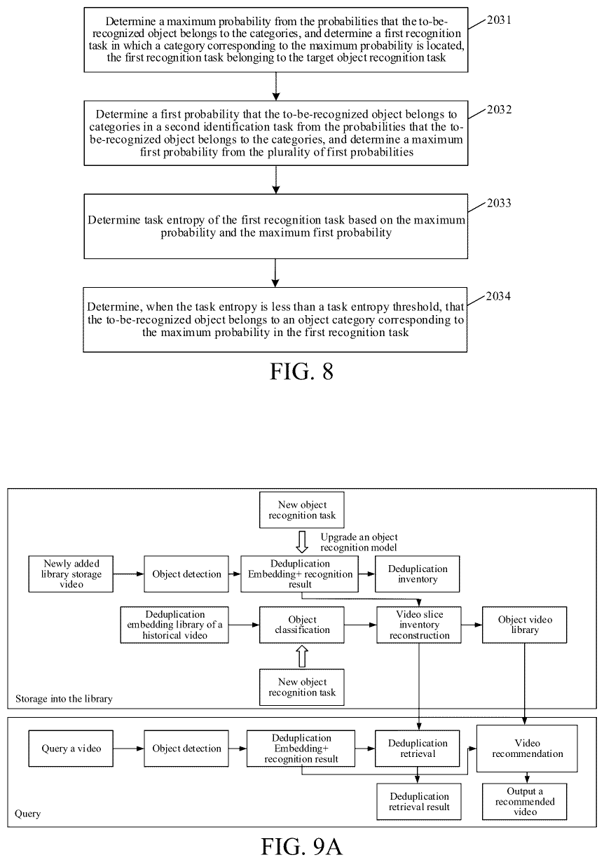

In some embodiments, FIG. 8 is a schematic flowchart of an object recognition model updating method according to some embodiments. FIG. 8 illustrates that operation 203 shown in FIG. 7 may be implemented by performing operation 2031 to operation 2034. Operation 2031: Determine a maximum probability from the probabilities that the to-be-recognized object belongs to the categories, and determine a first recognition task including a category corresponding to the maximum probability, the first recognition task belonging to the target object recognition task. Operation 2032: Determine first probabilities that the to-be-recognized object belongs to categories in a second recognition task from the probabilities that the to-be-recognized object belongs to the categories, and determine a maximum first probability from the plurality of first probabilities. The second recognition task is a recognition task other than the first recognition task in the target object recognition task. Operation 2033: Determine task entropy of the first recognition task based on the maximum probability and the maximum first probability. Operation 2034: Determine, when the task entropy is less than a task entropy threshold, that the to-be-recognized object belongs to an object category corresponding to the maximum probability in the first recognition task.

Operation 2031 is to determine the first recognition task includes the category corresponding to the maximum probability. Operation 2032 is to determine the first probability and the maximum first probability that the to-be-recognized object belongs to the various categories in the second recognition task (a recognition task different from the first recognition task in the target object recognition task). Operation 2033 is to determine the task entropy of the first recognition task based on the maximum probability and the maximum first probability. The task entropy may be obtained by using the following formula: task entropy=−a*ln(a)−b*ln(b), where a represents the maximum first probability, and b represents the maximum probability. A smaller task entropy may represent a larger probability that the to-be-recognized object belongs to an object category in the first recognition task. Therefore, a task entropy threshold may be determined in advance. When the task entropy corresponding to the to-be-recognized object is less than the task entropy threshold, it is determined that the to-be-recognized object belongs to the object category in the first recognition task, for example, the to-be-recognized object belongs to the object category corresponding to the maximum probability in the first recognition task. By determining a magnitude relationship between the task entropy and the task entropy threshold, the target category to which the to-be-recognized object belongs may be distinguished from other categories, which may increase accuracy of object recognition.

In some embodiments, when the task entropy is not less than the task entropy threshold, the server may determine the object category to which the to-be-recognized object belongs in the following manner: determining, when one second recognition task exists, that the to-be-recognized object belongs to a first category in the second recognition task, the first category corresponding to the maximum first probability; or when a plurality of second recognition tasks exist, determining, based on the first probability that the to-be-recognized object belongs to categories in a second recognition task, the object category to which the to-be-recognized object belongs.

When a plurality of second recognition tasks exist, the implementation of operation 203 may also be used to determine whether the to-be-recognized object belongs to a category in the second recognition task, and determine the object category in the second recognition task to which the to-be-recognized object belongs. A maximum probability may be determined from the probabilities to which the to-be-recognized object belongs to the various categories in the second recognition task, and a target second recognition task to which a category corresponding to the maximum probability belongs may be determined. First probabilities that the to-be-recognized object belongs to categories in a third recognition task are determined from the probabilities that the to-be-recognized object belongs to the categories in the second recognition task, and a maximum first probability is determined from the plurality of first probabilities corresponding to the third recognition task. The third recognition task is a recognition task other than the target second recognition task in the plurality of second recognition tasks. Task entropy of the target second recognition task is determined based on the maximum probability and the maximum first probability. When the task entropy is less than a task entropy threshold, it is determined that the to-be-recognized object belongs to an object category corresponding to the maximum probability in the target second recognition task. When the task entropy is not less than a task entropy threshold (indicating that the to-be-recognized object does not belong to the target second recognition task), when one third recognition task exists, it is determined that the to-be-recognized object belongs to a first category in the third recognition task, the first category corresponding to the maximum first probability in the third recognition task; or when a plurality of third recognition tasks exist, the object category to which the to-be-recognized object belongs is determined based on the first probability that the to-be-recognized object belongs to categories in the third recognition task. For processing operations performed when a plurality of third recognition tasks exist, reference may be made to processing operations when a plurality of second recognition tasks exist. By analogy, the object category, in the target recognition task, to which the to-be-recognized object belongs may be determined.

According to some embodiments, the object recognition model obtained through training in some embodiments has a category center parameter. The category center parameter is determined based on the sample features of the image samples in each of the training sample sets, and can be obtained without performing model training. When a capability of recognizing a new object recognition task is to be added to the object recognition model, a target category center parameter may be determined based on the sample features of the image samples in each of the training sample sets of the object recognition task and sample features of the image samples in the target training sample set of the new object recognition task, and the category center parameter of the object recognition model is updated to the target category center parameter, and re-training the object recognition model may be avoided. The obtained target object recognition model may have a capability of recognizing the at least one object recognition task and a capability of recognizing the new object recognition task. Because re-training the object recognition model may be avoided, the following technical effects may be achieved: (1) Implementation efficiency of adding a capability of recognizing a new object recognition task to the object recognition model is improved. (2) While the capability of recognizing the new object recognition task is added to the object recognition model, a recognition effect of an original object recognition task of the object recognition model is not affected, thereby ensuring the recognition effect of the target object recognition model for the original object recognition task, and improving recognition accuracy of the target object recognition model to which the new object recognition task has been added.

The following describes some embodiments in an application scenario. Before some embodiments are described, an example object recognition model is first described. For different object recognition tasks (for example, recognition of various categories of game objects in different games), recognition may be implemented by training an object recognition model by using training samples of the object recognition tasks. When a new object recognition task is added, the object recognition model is re-trained by using training samples of the new object recognition task, and the object recognition model may have a capability of recognizing the new object recognition task. This implementation has low efficiency. In addition, retraining of the new object recognition task may affect the recognition effect for the original object recognition task.

Some embodiments provide an object recognition model updating method, which may address the foregoing problems. In some embodiments, the object recognition model may be configured to perform recognition on various categories of game objects in at least one game recognition task. Detailed descriptions are provided below.

(1) Object detection. An object detection model is used to perform object detection on each frame of video image in an object video (for example, a game video including a game object), to provide an object screenshot (for example, an image sample of an object) for extraction of embedding features (for example, the foregoing sample features) of objects of various categories. The object detection model may use an open-source yolov3 detector trained based on a coco dataset, or may use an object detector pre-trained based on service data (for example, a video image at each frame in a game video), for example.

(2) Construction of an object recognition model. The object recognition model may be constructed by using a deep learning method in machine learning.

(2.1) To implement fast recognition through the object recognition model, the object recognition model in some embodiments is based on an embedding feature extraction model, and the object recognition model is constructed based on the embedding feature extraction model. In the object recognition model in some embodiments, feature extraction may not be performed on the object image of the to-be-recognized object from a bottom layer. This reduces occupation of inference computing resources, and facilitates rapid increase of new object recognition tasks. Therefore, embedding features extracted through the embedding feature extraction model in some embodiments has a representation capability across object recognition tasks.

(2.2) To quickly add a new object recognition task to the object recognition model under limited sample data, an object recognition layer of the object recognition model may be designed with few to-be-learned parameters. This is because more to-be-learned parameters may use a larger amount of sample data. Sample data available for the new object recognition task may be limited and may not support many to-be-learned parameters.

(2.3) The object recognition model may have a capability of distinguishing an object in a target recognition task from an object in a background recognition task among a plurality of different object recognition tasks. For example, for a game recognition task 1, all objects in a game recognition task other than the game recognition task 1 belong to objects in the background recognition task. The object recognition model in some embodiments may have an out-of-domain data recognition capability, and the object recognition model may support determining a relationship between an object and an object recognition task.

(2.4) Adding a new object recognition task to the object recognition model is a dynamic process. For example, the object recognition model supports recognition of objects of class n1 in one object recognition task. By using the object recognition model updating method provided in some embodiments, a new object recognition task (for recognition of objects of class n2 in the new object recognition task) may be added for the object recognition model, and the object recognition model may support recognition of two object recognition tasks. By analogy, the object recognition model can support recognition of more object recognition tasks. An object classification model for the objects of class n1 in one object recognition task may first be trained. When a new object recognition task is added, an object classification model for objects of class (n1+n2) is trained, and so on. However, since a model classification branch parameter may be changed again (changed from class n1 to class (n1+n2)), compared with a model classification effect of the object classification model for the objects of class n1, a model classification effect of the object classification model for the objects of class (n1+n2) may change significantly, and the object classification effect for some categories may be degraded. Therefore, in some embodiments, while the classification of the objects of class n1 is maintained, a branch of classification of the objects of class n2 may be newly added, and impact of a new object recognition task on an existing object recognition task may be more controllable and may help avoid repeat training. This may also be more conducive to targeted optimization of service upgrading and maintenance of an object recognition task.

(3) Model structure of the object recognition model. The object recognition model may be constructed based on the embedding feature extraction model. Structures of the embedding feature extraction model are shown in Table 1 (basic feature extraction layer) and Table 2 (embedding feature extraction layer), and a structure of the object recognition model is shown in Table 3. An input of the basic feature extraction layer shown in Table 1 is an object image of the to-be-recognized object. An output of the basic feature extraction layer shown in Table 1 is an input of the embedding feature extraction layer shown in Table 2. An output of the embedding feature extraction layer shown in Table 2 is an input of the object recognition model shown in Table 3. An output of the object recognition model shown in Table 3 is the object category of the to-be-recognized object. The embedding feature extraction model includes the foregoing convolution feature extraction layer (Conv1 to Conv5 shown in Table 1), the pooling feature extraction layer (Pool shown in Table 2), and the embedding feature extraction layer (Embedding shown in Table 2).

TABLE 1
Structure table of a ResNet-101 basic feature extraction layer

| Layer name | Output size | ResNet-101 | |
|---|---|---|---|
| Conv1 | 300 × 500 | 7 × 7, 64, stride 2 | |
| Conv2 | 150 × 250 | 3 × 3 maxpool, stride 2 | |
| | | 1 × 1, 64 | ×3 blocks |
| | | 3 × 3, 64 | |
| | | 1 × 1, 256 | |
| Conv3 | 76 × 126 | 1 × 1, 128 | ×4 blocks |
| | | 3 × 3, 128 | |
| | | 1 × 1, 512 | |
| Conv4 | 38 × 63 | 1 × 1, 256 | ×23 blocks |
| | | 3 × 3, 256 | |
| | | 1 × 1, 1024 | |
| Conv5 | 38 × 63 | 1 × 1, 512 | ×3 blocks |
| | | 3 × 3, 512 | |
| | | 1 × 1, 2048 | |

TABLE 2
Structure table of an embedding feature extraction layer

| Layer name | Output size | Layer |
|---|---|---|
| Pool | 1 × 2048 | Pooling layer |
| Embedding | 1 × 128 | Full connected layer |

An input of the embedding feature extraction layer shown in Table 2 is an output of the basic feature extraction layer shown in Table 1. In consideration of compatibility during application of the object recognition model, the embedding feature extraction model may be pre-trained, and the object recognition model may be constructed based on the embedding feature extraction model. During training of the object recognition model in some embodiments, the model parameters of the embedding feature extraction model may not be changed. During training of the object recognition model, the model parameters of the models shown in Table 1 and Table 2 may not be updated.

TABLE 3
Structure table of an object recognition model

| Layer name | Output size | Layer |
|---|---|---|
| Fc | 1 × 128 | Full connected layer |
| Normalization | 1 × 128 | Full connected layer |
| Cosine match | 1 × Nx | Full connected layer |
| Softmax | 1 × Nc | Full connected layer |

The input of the object recognition model shown in Table 3 is the output of the embedding feature extraction layer shown in Table 2, for example, Embedding. In the object recognition model shown in Table 3, non-linear mapping may be performed on the embedding feature through a fully connected (Fc) layer (for example, the foregoing feature mapping layer), to obtain a mapping feature. Normalization may be performed on the mapping feature through a normalization layer (each element in the input vector is divided by a modulus of the vector), and the mapping feature may be normalized to a unit hypersphere. Next, first object recognition is performed through the sine-match layer (for example, the first object recognition layer), to obtain predicted probabilities that the to-be-recognized object belongs to the category centers. Nx represents a quantity of centers of the category centers included in the category of the object supported by the object recognition model, and Nc represents a quantity of categories of the object supported by the object recognition model. For example, when the object recognition model supports recognition of 81 categories of game objects, Nc=81, and Nx is determined by the quantity of centers of the category centers of the game objects of each category. Predicted probabilities that the to-be-recognized object belongs to the categories may be determined through the Softmax layer (for example, the second object recognition layer), and the predicted probabilities for the categories may be mapped to between 0 and 1.

Each category includes at least one category center. For example, in a game recognition task, the category center may be at least one game object archetype of a game object to which a category belongs. The game object archetypes are different expression forms of the game object. For example, standard object styles of the game object when the game object casts a game skill 1, casts a game skill 2, casts a game skill 3, stands, and walks may be considered as five game object archetypes of the game object.

TABLE 4
Category center parameter

| Layer name | Output size | Layer |
|---|---|---|
| W | Nx × 128 | Full connected layer |

No model parameter that is to be learned may be set for the Normalization layer, the cosine-match layer, or the Softmax layer. Since the Fe layer generates Embedding for object recognition, a model parameter that is to be learned may be set. A category center parameter w of an object recognition model may be set for the cosine-match layer. The category center parameter w is generated based on a sample feature of a training sample, and is obtained without performing model training. The sample feature may be based on Embedding of the training sample generated by the Fc layer. Therefore, in a learning process of the object recognition model, based on each model iteration ending, the category center parameter w (shown in Table 4) of the object recognition model may be updated. When a new object recognition task is added to the object recognition model, adding may be implemented by updating the category center parameter w of the object recognition model.

(4) Training process of an object recognition model.

(4.1) Data preparation. Image samples that are of objects of various categories in each object recognition task among object recognition tasks of the target quantity and that are to be learned are collected to construct training sample sets of each of the object recognition tasks. The training sample sets of object recognition tasks of the target quantity may be referred to as basic training sample sets. For example, image samples of a target quantity may be collected for objects of various categories in the object recognition tasks, for example, 25 image samples (where it is ensured that more than 20 image samples are used in a training set and 5 image samples are used in a test set). When the object recognition model is trained based on the training sample set of the object recognition tasks, one object recognition task may be randomly designated as a target recognition task (for example, a game recognition task 1) from the object recognition tasks of the target quantity. Categories in the target recognition task may be target categories, and categories in other recognition tasks may be background categories. After training of the training sample set based on the target recognition task ending, the object recognition model may be configured to recognize whether the to-be-recognized object is a target category or background category and recognize a category in the target categories. Further, after training on the training sample based on the target recognition task ending, an object recognition task (different from a previous object recognition task) may be randomly designated as the target recognition task from the object recognition tasks of the target quantity for training. By analogy, to train the object recognition model based on the training sample sets of the object recognition tasks.

(4.2) Training on an object recognition model. During final application of the object recognition model, categories of objects supported for recognition change (for example, currently connected to a game recognition task 1, newly connected to a game recognition task 2 after two weeks, and the like). In addition, a quantity of image samples of objects in each category may be not large (for example, more than 25). To support quickly adding a new object recognition task to the object recognition model, the object recognition model may be applied to the new object recognition task without re-training the object recognition model during final application. In some embodiments, the training and data sampling processes of the object recognition model may support directly updating the object recognition model without re-training the object recognition model to support a downstream object recognition task (for example, a newly added object recognition task). When training the object recognition model, an object recognition task may be randomly selected from the target quantity of object recognition tasks as the target recognition task before starting training, a training sample set of the target recognition task may be constructed while ensuring close distribution to the real data, and the target recognition task may be trained based on the training sample set, to achieve a training end standard of the target recognition task (for example, training for a quantity of times N_project). Another object recognition task may be randomly selected as a target recognition task, a training sample set may be constructed, and the target recognition task may be trained, and the like, until the object recognition tasks reach a training end criterion.

(4.2.1) Construction of a training sample set. One object recognition task is randomly selected from the target quantity of object recognition tasks as the target recognition task, objects of n (for example, n=30) categories in the target recognition task, and k1 image samples are sampled on an object i of each category respectively, to obtain a training sample set of the target recognition task. For example, k1 may satisfy the following condition: k1=max (N_i_sample, 25), where N_i_sample is a random value selected in the range of [25, a total quantity of image samples of an object i of each category], and a quantity of image samples of an object i of each category may not be less than 25. The remaining k2 (for example, 5) image samples may be selected from the image samples of the objects in the n categories to construct the test set. Based on a number of (for example, 10) iterations (epochs) of training being performed by using the training sample set, the training of the training sample set may be completed. Another target recognition task may be randomly generated, a training sample set and a test set may be constructed, and a new round of training may be continued, and the like, until convergence (for example, loss no longer decreases, or a test result accuracy no longer improves). The quantity limit of k1 is to satisfy that, when a sample size is insufficient, the sample sizes of the categories are balanced (the same), to ensure that the categories have an equal chance of being learned, and improve a model training effect. In addition, a recognition capability of the object recognition model may be improved under limited training samples. If a sample size is sufficient, a value of k1 may be set, and is not limited to the foregoing conditions met by k1.

(4.2.2) Model parameter update process in training. In some embodiments, model parameters in the object recognition model are updated by using a stochastic gradient descent (SGD) method, including a convolution template parameter α and a bias parameter β. In each iteration process, an error of the prediction result is calculated and backpropagated to the object recognition model, a gradient is calculated, and model parameters of the object recognition model are updated. A process may include setting all to-be-learned parameters of the object recognition model to a state that is to be learned. During training, the object recognition model performs forward calculation on inputted image samples to obtain a prediction result, compares the prediction result with labels of the image samples, calculates a loss value of the object recognition model, returns the loss value to the object recognition model, and updates model parameters by using a stochastic gradient descent method. Model parameter optimization is implemented once, and a plurality of times of optimization are performed, to obtain an object recognition model.

(4.2.3) Category center parameter. As shown in FIG. 6, a category center parameter w of the object recognition model is set at the sine-match layer, and is configured for representing a plurality of category centers [u1 . . . uN] corresponding to categories in object recognition tasks. In some embodiments, each category includes a plurality of category centers. For example, in a game recognition task, the category centers may be a plurality of game object archetypes of a game object to which a category belongs. The game object archetypes are different expression forms of the game object. For example, standard object styles of the game object when the game object casts a game skill 1, casts a game skill 2, casts a game skill 3, stands, and walks may be considered as five game object archetypes of the game object. Since other actions and states of the game object may be considered as resulting from minor changes in the five game object archetypes, the object recognition model may only learn expressions (for example, category center parameters) of the five game object archetypes, to ensure that a game object in a state in an image sample can find a corresponding game object archetype. By setting the category center parameter w for the object recognition model, the object recognition model may only learn the category center parameter w, to ensure that the to-be-recognized object can find the category center to which the to-be-recognized object belongs during object recognition. In some embodiments, there may be a plurality of category centers, and not every image sample may converge towards one category center (for example, one game object prototype), thereby avoiding the loss of diversity in the object representation due to the object representation being too close to a unique single center, further avoiding the inability of the object representation to support object weighting at the same time, as well as other problems of object recognition, for example, avoiding the overfitting problem of object recognition in single-center classification to multi-recognition tasks.

Generation of the category center parameters: A sample embedding feature output by the Fc layer shown in Table 3 is generated for each image sample of the objects. Clustering processing of Kn cluster centers, for example, clustering processing of 5 cluster centers, may be performed on all sample embedding features of each object, to obtain Kn category centers, and the Kn category centers may be recorded in a category memory unit. The Kn category centers are configured to construct a category center parameter. For example, the object recognition model in the current training phase supports recognition of objects in 81 categories (including 80 target categories of target recognition tasks in the target quantity of object recognition tasks, and the remaining one category is a background category). For the target recognition task, Kn category centers may be generated for objects of the target categories in the target recognition task, and a total of 80 Kn category centers may be obtained. r*Kn category centers may be generated for other categories (for example, background categories, which are categories in recognition tasks other than the target recognition task in the object recognition tasks of the target quantity), where r=Nothers/Nhero (Nhero represents a quantity of image samples of objects in the other categories, and Nothers represents a quantity of full image samples of the objects in the other categories). For example, Nothers=1000, and Nhero=25. In this case, r=40. For the current object recognition model, Kn=5, Nc=81, and a total quantity of category centers is represented by Nx=(Nc−1)*Kn+r*Kn=600.

Update of the category center parameter: The category center parameter is generated based on the sample feature of the training sample, and is obtained without performing model training. The sample feature may be based on Embedding of the training sample generated by the Fc layer of the object recognition model. Therefore, in a learning process of each object recognition task, since the model parameter of the object recognition model changes based on each iteration ending, the category center parameter w of the object recognition model may be updated. During update, the category center parameter generation method may be used for implementation.

(4.2.4) Loss calculation of the object recognition model. For each image sample, the object recognition model is used to generate the sample embedding feature (denoted as p) output by the Fc layer shown in Table 3, and cosine similarities between p and all the Nx category centers may be calculated, to obtain a prediction result of the image sample in each category center. Among the Kn category centers of the categories that are labelled in advance, a category center (denoted as y) with the largest cosine similarity is selected as a target of the sample embedding feature that the image sample is to learn. In addition, cosine similarities between p and category centers of other non-categories are to be reduced. A loss of each image sample may be determined by using Formula (1):

$$loss = yp - \frac{1}{N x - K n} {\sum }_{j = 1}^{N x - K n} {y}_{j} p ; \qquad ( 1 )$$

yp represents a cosine similarity.

$$- \frac{1}{N x - K n} {\sum }_{j = 1}^{N x - K n} {y}_{j} p$$

indicates that the larger the Euclidean distance between the image sample and the category center of the other categories, the better. yⱼ represents category centers of other categories (including a background category and a category different from a real category of the image sample in the recognition task corresponding to the image sample). A value j is in a range of [1, Nx−Kn=(Nc−2)*Kn+r*Kn]. Nc is a total quantity of categories (including the background category) to be learned by the object recognition task. (Nc−2) represents a quantity of categories remaining after the background category and the real category (the real category of the image sample) are removed. r*Kn represents a quantity of category centers of the background category.

For each training sample set, a sample loss is calculated for each image sample in the training sample set based on Formula (1), and an average value of sample losses may be calculated to obtain the loss of the object recognition model.

(5) Application of the object recognition model. Object recognition is performed on the object image of each to-be-recognized object through the sine-match layer shown in Table 3, to obtain predicted values (for example, predicted probabilities) that the to-be-recognized object belongs to the category centers, for example, the predicted values of the Nx category centers are output. From the predicted values of the plurality of category centers of each category, a maximum predicted value may be taken as the predicted value for the category, to obtain the predicted values of the Nc categories. The predicted values of the categories are mapped between 0 and 1, to obtain the prediction results for the to-be-recognized object of the Nc categories.

(6) Add a new object recognition task to the object recognition model. The foregoing process trains object classification representation (for example, extraction of Embedding), to ensure that the object recognition model can support the addition of a new object recognition task without re-training when the object recognition task changes. A target training sample set of the new object recognition task may be constructed (for example, a quantity of image samples of objects of various categories in the new object recognition task). The Embedding of the image samples in the target training sample set may be obtained based on the Fc layer of the object recognition model, and the cosine similarities between the Embedding of the image samples in the target training sample set and the Embedding of the image samples in the basic training sample set may be calculated, and 5% of the image samples with the largest cosine similarities may be screened out from the basic training sample set to obtain the target basic training sample set. A target category center parameter may be generated based on the target basic training sample set and the target training sample set, and an original category center parameter of the object recognition model is updated by using the target category center parameter, to obtain the target object recognition model. The object recognition model may support a new object recognition task.

(7) When the class of the object is recognized, interference of the background class object to the target class object is controlled. The determining a task entropy threshold first before the object recognition model is applied includes: 1) inputting all test samples into the object recognition model to obtain predicted values of the Nc categories; and 2) Determine a maximum predicted value (such as 0.7) among the Nc categories, and determine a background category different from the category corresponding to the maximum predicted value among the Nc categories and a maximum background category prediction value among the background categories. 3) Calculate, for each test sample, entropy of the maximum prediction value and the maximum background class prediction value, as entropy of a target recognition task to which the test sample belongs to a class (for example, a category corresponding to the maximum prediction value), which is referred to as task entropy of the test sample. For example, for a test sample with a maximum background category prediction value of 0.1 and a maximum prediction value of 0.7, the task entropy thereof is obtained as follows: −0.1*ln(0.1)−0.7*ln(0.7)=0.48. For a test sample with a maximum background category prediction value of 0.45 and a maximum prediction value of 0.45, the task entropy thereof is 0.72. It can be seen that, when the task entropy is greater, it indicates that there is a smaller probability that the test sample belongs to a category in the target recognition task. 4) Perform, on the task entropy of all the test samples, according to whether the test samples belong to a category in the target recognition task, threshold search in a range of “0.10 to 0.99” with a step size of 0.02 as a step size, to find a task entropy threshold thr that can be configured for distinguishing whether the test samples belong to the category in the target recognition task.

When the object recognition model is used to perform object recognition, an object image of a to-be-recognized object is first inputted into the object recognition model, prediction values of various categories are output, and a maximum prediction value and a corresponding target category are determined. Task entropy of the object image may be calculated. When the task entropy is less than a task entropy threshold thr, and the maximum prediction value is greater than the maximum background category prediction value, it is considered that the to-be-recognized object is the target category, otherwise, it is considered that the to-be-recognized object is the background category. Since there are a wide range of background categories, an object in the background category may be similar to an object in the target category. If the maximum value in the predicted values is directly taken, the background category object may be recognized as the target category object. Therefore, information judgment is to be performed with the help of entropy. When the target class cannot be distinguished from the background class, the entropy is always large. The information entropy and the probability measure may be jointly assessed to improve accuracy of object recognition.

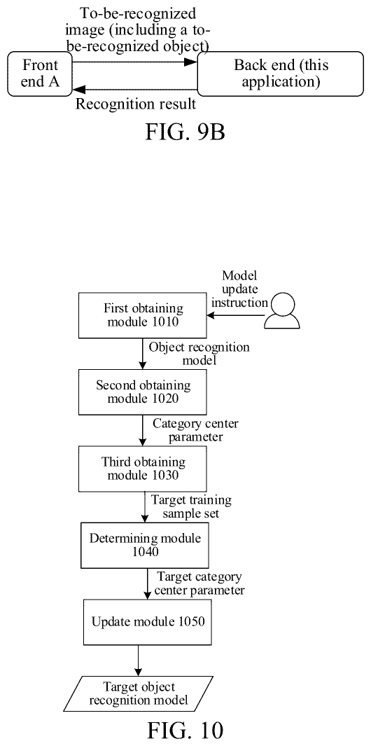

FIG. 9A is a schematic diagram of application of an object recognition model according to some embodiments. 1) For a newly-added library video: a) Object detection is performed on frames in the video through the object detection model, to obtain an object screenshot. b) The to-be-recognized object in the object screenshot is recognized through the object recognition model provided in some embodiments, to obtain a duplication Embedding+recognition result, where the duplication Embedding is the output in Table 2, and the recognition result is the output in Table 3. c) Save the deduplication Embedding of the video in a deduplication inventory from front to back according to the frame number in the video, and record a frame number corresponding to each deduplication Embedding, and which deduplication Embedding exists under each frame number.

2) Reconstruction of an inventory of video slices: According to an Embedding deduplication library of historical videos, object recognition is performed on Embedding deduplication by using the object recognition model in Table 3 above, to obtain a recognition result of each Embedding deduplication. According to the recognition result of Embedding deduplication under each frame number of the video, when the first two frames all include the same object (for example, both contain an A object), the first two frames all belong to a video clip of an object. Objects may be merged for all frames of the video, and according to a time period in which the objects appear, and each video clip corresponds to an object, a frame may be discarded when a plurality of objects appear in the frame), saving the video clip and the deduplication Embedding of the object corresponding to the video clip to the object video library, and the playing amount of the original video in which the video clip is located can be saved as the hotness value of the object.

3) When a video is queried based on a query object (such as a game object), deduplication retrieval may be performed on a plurality of queried videos. Therefore, object detection is first performed on the inputted query video (including the query object), deduplication Embedding and a recognition result of the query video are extracted, and retrieval weights of objects in the query video are obtained according to the recognition result. Querying is performed, by using the deduplication Embedding, on a similar inventory Embedding from the deduplication inventory (taking a threshold of a similarity degree of the deduplication Embedding as Ks, and indicating similarity when the similarity exceeds the threshold Ks), and a video to which the similar inventory Embedding belongs is recalled from the video slice library based on the retrieval weight. A similarity between the inventory Embedding of each recalled video and the duplication Embedding of the query video is calculated according to the inventory Embedding of the recalled video, a quantity of frames of similar frames with each other is counted according to a threshold, and a repetition ratio of the two videos is obtained according to a ratio of the quantity of frames of similar frames to the total quantity of frames. The deduplication search result corresponding to the query video may be output according to the repetition ratio.

4) For video recommendation, obtain, from the object video inventory according to the query object, a video corresponding to inventory Embedding similar to the deduplication Embedding of the query object as a recall video, compare an object category of the recall video with an object category of the query video, and if the object categories are different, not recall the video. Recall videos with the same object categories may be sorted in descending order according to the popularity values, and according to a sorting result, a recommended video may be output to the user.

5) Adding a new object recognition task: The object recognition model is upgraded, and a new object recognition task is added to the object recognition model. During construction of the new object recognition task, after a new category center parameter supporting the new object recognition task is generated based on the foregoing steps, for the new object recognition task, object recognition is performed in combination with the new category center parameter. For different new object recognition tasks to be added, based on the object recognition model, object recognition may be directly performed in combination with the new category center parameter of the new object recognition task.

FIG. 9B is a schematic diagram of application of an object recognition model according to some embodiments. The front end A receives the to-be-recognized image (including the to-be-recognized object), and uploads the image to the back end. The back end uses the object recognition model provided in some embodiments to recognize the to-be-recognized object, outputs a recognition result (for example, an object category to which the to-be-recognized object belongs), and returns the recognition result to the front end A.

According to some embodiments, the following technical effects can be achieved: a) providing a capability of learning object recognition under limited training samples, and impact on recognition of objects of a target class due to the presence of a large number of objects of other classes at the same time may be reduced, and feature expression capabilities under limited samples may be improved; and b) providing an incremental learning capability for a new object recognition task that does not affect an existing object recognition capability, which can ensure a recognition effect of each object recognition task.

The following describes an apparatus for updating an object recognition model provided in some embodiments. FIG. 10 is a schematic flowchart of an object recognition model updating method according to some embodiments. The object recognition model updating apparatus provided in some embodiments includes:

a first obtaining module 1010, configured to obtain an object recognition model, the object recognition model being configured to recognize objects of a plurality of categories in at least one object recognition task, the object recognition model being obtained through training based on training sample sets of the object recognition tasks, and each of the training sample sets of each of the object recognition tasks including image samples of the objects of the various categories in the object recognition task; a second obtaining module 1020, configured to obtain a category center parameter of the object recognition model, the category center parameter being determined based on sample features of the image samples in each of the training sample sets; a third obtaining module 1030, configured to obtain a target training sample set of a new object recognition task, the target training sample set including image samples of objects of a plurality of categories in the new object recognition task; a determining module 1040, configured to determine a target category center parameter based on the sample features of the image samples in each of the training sample sets and sample features of the image samples in the target training sample set; and an update module 1050, configured to update the category center parameter of the object recognition model to the target category center parameter, to obtain a target object recognition model, the target object recognition model being configured to recognize, based on the target category center parameter, a target category to which a to-be-recognized object belongs, the target category being one of the following categories: the plurality of categories in the new object recognition task or the plurality of categories in the at least one object recognition task.

In some embodiments, the first obtaining module 1010 is further configured to: obtain an initial object recognition model, and obtain the training sample sets of the object recognition tasks, the image samples in each of the training sample sets being annotated with labels; obtain the sample features of the image samples in each of the training sample sets, and determine the category center parameter of the object recognition model based on the sample features of the image samples in each of the training sample sets; separately perform, through the initial object recognition model, object recognition on the image samples in each of the training sample sets based on the category center parameter, to obtain recognition results for the image samples; and update a model parameter of the initial object recognition model based on a difference between the labels and the recognition results for the image samples, to obtain the object recognition model, the model parameter being different from the category center parameter.

In some embodiments, the first obtaining module 1010 is further configured to perform the following operations for each of the object recognition tasks: obtaining an object video of the object recognition task, the object video including a plurality of frames of video images; determining a plurality of frames of target video images in the plurality of frames of video images, each of the target video images including the objects of the plurality of categories in the object recognition task; selecting, for the objects of the various categories in the object recognition task, a target quantity of first video images including the objects of the categories from the plurality of frames of target video images, and using the first video images as the image samples of the objects of the categories; and constructing the training sample sets of the object recognition tasks based on the image samples of the objects of the various categories in the object recognition task.

In some embodiments, the first obtaining module 1010 is further configured to separately perform, through the feature extraction layer, feature extraction on the image samples in each of the training sample sets, to obtain the sample features of the image samples. Correspondingly, the first obtaining module 1010 is further configured to: based on updating the model parameter of the initial object recognition model, separately performing feature extraction on the image samples in each of the training sample sets through the feature extraction layer updated by using the model parameter, to obtain new sample features of the image samples; determine a new category center parameter of the object recognition model based on the new sample features of the image samples in each of the training sample sets; and update the category center parameter of the object recognition model to the new category center parameter.

In some embodiments, a plurality of image samples of the objects of the various categories in each of the training sample sets exist, and the first obtaining module 1010 is further configured to: determine a plurality of sample features corresponding to the objects of the various categories from the sample features of the image samples in each of the training sample sets; cluster, for the plurality of sample features corresponding to the objects of the various categories, the plurality of sample features based on a target quantity of cluster centers, to obtain a target quantity of sample feature clusters; and generate the category center parameter of the object recognition model based on target sample features corresponding to the cluster centers of the sample feature clusters.

In some embodiments, the category center parameter includes a plurality of subcategory center parameters, and the subcategory center parameters are in a one-to-one correspondence with category centers of the various categories in the at least one object recognition task; and the first obtaining module 1010 is further configured to: separately perform feature extraction on the image samples in each of the training sample sets, to obtain the sample features of the image samples; perform first object recognition on the sample features of the image samples in each of the training sample sets based on the subcategory center parameters, to obtain probabilities that objects in the image samples belong to the category centers; and determine, for the image samples and based on the probabilities that the objects in the image samples belong to the category centers, categories to which the objects in the image samples belong, and using the categories to which the objects in the image samples belong as the recognition results.

In some embodiments, the first obtaining module 1010 is further configured to: separately perform convolution processing on the image samples in each of the training sample sets, to obtain convolution features of the image samples; separately perform pooling processing on the convolution features of the image samples, to obtain pooling features of the image samples; perform embedding feature extraction processing on the pooling features of the image samples, to obtain embedding features of the image samples; perform feature mapping processing on the embedding features of the image samples, to obtain mapping features of the image samples; and perform normalization processing on the pooling features of the image samples, to obtain the sample features of the image samples.

In some embodiments, M object recognition tasks exist, and the first obtaining module 1010 is further configured to: obtain an initial object recognition model, and obtain training sample sets of each of the object recognition tasks; train the initial object recognition model based on a training sample set of the 1^{st} object recognition task, to obtain an intermediate object recognition model of the 1^{st} object recognition task; train an intermediate object recognition model of an (i−1)^{th} object recognition task by using a training sample set of an i^{th} object recognition task, to obtain an intermediate object recognition model of the i^{th} object recognition task; and traverse i object recognition tasks to obtain an intermediate object recognition model of an M^{th} object recognition task, and using the intermediate object recognition model of the M^{th} object recognition task as the object recognition model, where M and i are integers greater than 1, and i is less than or equal to M.

In some embodiments, a plurality of image samples of the objects of the various categories in each of the training sample sets exist, and a plurality of image samples of objects of various categories in the target training sample set exist; and the determining module 1040 is further configured to: determine a plurality of sample features corresponding to the objects of the various categories in each of the training sample sets from the sample features of the image samples in the training sample set, and determine a plurality of sample features corresponding to the objects of the various categories in the target training sample set from the sample features of the image samples in the target training sample set; cluster, for the plurality of sample features corresponding to the objects of the various categories, the plurality of sample features based on a target quantity of cluster centers, to obtain a target quantity of sample feature clusters; and generate the target category center parameter based on target sample features corresponding to the cluster centers of the sample feature clusters.

In some embodiments, the determining module 1040 is further configured to: perform the following operations for each of the training sample sets: determining, for the sample features of the image samples in the training sample set, feature similarities between the sample features of the image samples and the sample features of the image samples in the target training sample set; screening, from the training sample set, sample features of the image samples with a feature similarity satisfying a similarity condition, to obtain first training sample sets; and determining the target category center parameter based on the sample features of the image samples in each of the first training sample sets and the sample features of the image samples in the target training sample set.

In some embodiments, the target category center parameter includes a plurality of target subcategory center parameters, the target subcategory center parameters are in a one-to-one correspondence with category centers of various categories in a target object recognition task, and the target object recognition task includes the at least one object recognition task and the new object recognition task; and the update module 1050 is further configured to: perform first object recognition on an object image of the to-be-recognized object based on the target subcategory center parameters through the target object recognition model, to obtain initial probabilities that the to-be-recognized object belongs to the category centers; determine, based on the initial probabilities corresponding to the category centers, probabilities that the to-be-recognized object belongs to the categories; and determine, based on the probabilities that the to-be-recognized object belongs to the categories, an object category to which the to-be-recognized object belongs.

In some embodiments, when a plurality of category centers of the various categories exist, the update module 1050 is further configured to perform the following operation for each of the various categories: determining a maximum initial probability from the initial probabilities corresponding to the category centers of the category, and determining the maximum initial probability as a probability that the to-be-recognized object belongs to the category.

In some embodiments, the update module 1050 is further configured to: determine a maximum probability from the probabilities that the to-be-recognized object belongs to the categories, and determine a first recognition task including a category corresponding to the maximum probability, the first recognition task belonging to the target object recognition task; determining first probabilities that the to-be-recognized object belongs to categories in a second recognition task from the probabilities that the to-be-recognized object belongs to the categories, and determining a maximum first probability from the plurality of first probabilities, where the second recognition task is a recognition task other than the first recognition task in the target object recognition task; determine task entropy of the first recognition task based on the maximum probability and the maximum first probability; and determine, when the task entropy is less than a task entropy threshold, that the to-be-recognized object belongs to an object category corresponding to the maximum probability in the first recognition task.

In some embodiments, when the task entropy is not less than the task entropy threshold, the update module 1050 is further configured to: determine, when one second recognition task exists, that the to-be-recognized object belongs to a first category in the second recognition task, the first category corresponding to the maximum first probability; or when a plurality of second recognition tasks exist, determine, based on the first probability that the to-be-recognized object belongs to categories in a second recognition task, the object category to which the to-be-recognized object belongs.

According to some embodiments, each module may exist respectively or be combined into one or more modules. Some modules may be further split into multiple smaller function subunits, thereby implementing the same operations without affecting the technical effects of some embodiments. The modules are divided based on logical functions. A function of one module may be realized by multiple modules, or functions of multiple modules may be realized by one module. In some embodiments, the apparatus may further include other modules. These functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

According to some embodiments, the object recognition model obtained through training in some embodiments has a category center parameter. The category center parameter is determined based on the sample features of the image samples in each of the training sample sets, and can be obtained without performing model training. When a capability of recognizing a new object recognition task is to be added to the object recognition model, a target category center parameter may be determined based on the sample features of the image samples in each of the training sample sets of the object recognition task and sample features of the image samples in the target training sample set of the new object recognition task, and the category center parameter of the object recognition model is updated to the target category center parameter, and re-training the object recognition model may be avoided. The obtained target object recognition model may have a capability of recognizing the at least one object recognition task and a capability of recognizing the new object recognition task. Because re-training the object recognition model may be avoided, the following may be achieved: (1) Implementation efficiency of adding a capability of recognizing a new object recognition task to the object recognition model is improved. (2) While the capability of recognizing the new object recognition task is added to the object recognition model, a recognition effect of an original object recognition task of the object recognition model is not affected, thereby ensuring the recognition effect of the target object recognition model for the original object recognition task, and improving recognition accuracy of the target object recognition model to which the new object recognition task has been added.

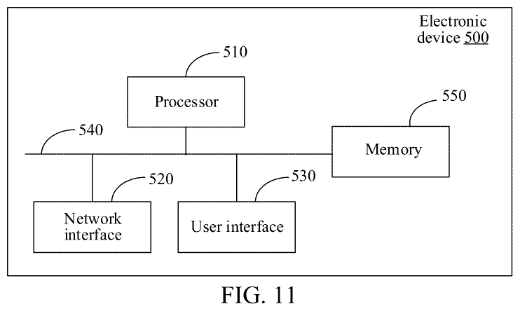

An electronic device implementing the object recognition model updating method provided in some embodiments is described below. FIG. 11 is a schematic structural diagram of an electronic device 500 implementing an object recognition model updating method according to some embodiments. The electronic device 500 may be a server, or may be a terminal. The electronic device 500 implementing the object recognition model updating method provided in some embodiments includes: at least one processor 510, a memory 550, at least one network interface 520, and a user interface 530. All the components in the electronic device 500 are coupled together by using a bus system 540. It may be understood that the bus system 540 is configured to implement connection and communication between the components. In addition to a data bus, the bus system 540 further includes a power bus, a control bus, and a status signal bus. However, for ease of clear description, all types of buses are marked as the bus system 540 in FIG. 11.

The processor 510 may be an integrated circuit chip having a signal processing capability, for example, a central processing unit (CPU), a digital signal processor (DSP), or another programmable logic device (PLD), discrete gate, transistor logical device, or discrete hardware component. The processor may be a microprocessor or the like.

The memory 550 may be a removable memory, a non-removable memory, or a combination thereof. The memory 550 includes one or more storage devices physically away from the processor 510. The memory 550 includes a volatile memory or a non-volatile memory, or may include both a volatile memory and a non-volatile memory. The non-volatile memory may be a read-only memory (ROM), and the volatile memory may be a random access memory (RAM); however, the disclosure is not limited thereto.

The memory 550 may store data to support various operations. Examples of the data include programs, modules, and data structures, or a subset or a superset thereof. In some embodiments, the memory 550 stores computer-executable instructions, the computer-executable instructions, when executed by the processor 510, causing the processor 510 to perform the object recognition model updating method provided in some embodiments.

Some embodiments provide a computer program product. The computer program product includes computer-executable instructions, and the computer-executable instructions are stored in a computer-readable storage medium. A processor of an electronic device reads the computer-executable instructions from the computer-readable storage medium and executes the computer-executable instructions, to cause the electronic device to perform the object recognition model updating method provided in some embodiments.

Some embodiments provide a computer-readable storage medium storing computer-executable instructions, the computer-executable instructions, when executed by a processor, causing the processor to perform the object recognition model updating method provided in some embodiments.

In some embodiments, the computer-readable storage medium may be a memory such as a RAM, a ROM, a flash memory, a magnetic surface memory, an optical disk, or a CD-ROM, or may be any device including one of or any combination of the foregoing memories.

In some embodiments, the computer-executable instructions can be written in a form of a program, software, a software module, or a script and according to a programming language (including a compiler or interpreter language or a declarative or procedural language) in any form, and may be deployed in any form, including an independent program or a module, a component, a subroutine, or another unit for use in a computing environment.

In an example, the computer-executable instructions may, but may not necessarily, correspond to a file in a file system, and may be stored in a part of a file that saves another program or other data, for example, be stored in one or more scripts in a hypertext markup language (HTML) file, stored in a file that is configured for a program in discussion, or stored in the plurality of collaborative files (for example, be stored in files of one or modules, or subprograms).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An object recognition model updating method, applied to an electronic device, comprising:
obtaining a first object recognition model through training based on one or more first training sample sets of one or more first object recognition tasks, wherein the one or more first training sample sets comprise one or more first image samples of a first plurality of objects of a first plurality of categories in the one or more first object recognition tasks;
determining a first category center parameter of the first object recognition model based on a first plurality of sample features of the one or more first image samples;
obtaining a second training sample set of a second object recognition task comprising one or more second image samples of a second plurality of objects of a second plurality of categories in the second object recognition task;
determining a second category center parameter based on the first plurality of sample features and a second plurality of sample features of the one or more second image samples; and
updating the first category center parameter to the second category center parameter, to obtain a second object recognition model,
wherein the second object recognition model is configured to recognize, based on the second category center parameter, a second category to which a third object to be recognized belongs, and
wherein the second category comprises one from among the second plurality of categories and the first plurality of categories.

2. The object recognition model updating method according to claim 1, wherein the obtaining the first object recognition model comprises:
obtaining a third object recognition model;
obtaining the one or more first training sample sets, wherein the one or more first image samples are annotated with labels;
obtaining the first plurality of sample features;
determining a third category center parameter of the third object recognition model based on the first plurality of sample features;
performing, through the third object recognition model, object recognition on the one or more first image samples based on the third category center parameter, to obtain a plurality of recognition results for the one or more first image samples; and
updating a model parameter of the third object recognition model based on a difference between the labels and the plurality of recognition results, to obtain the first object recognition model, wherein the model parameter is different from the third category center parameter.

3. The object recognition model updating method according to claim 2, wherein the obtaining the one or more first training sample sets comprises:
obtaining an object video of an object recognition task of the one or more first object recognition tasks comprising a first plurality of frames of video images;
determining a second plurality of frames of target video images in the first plurality of frames comprising a third plurality of objects of a third plurality of categories in the object recognition task;
selecting, for the third plurality of objects, a target quantity of first video images comprising the third plurality of objects from the second plurality of frames;
using the first video images as the one or more first image samples; and
constructing the one or more first training sample sets based on the one or more first image samples.

4. The object recognition model updating method according to claim 2, wherein the third object recognition model comprises a feature extraction layer,
wherein the obtaining the first plurality of sample features comprises:
performing, through the feature extraction layer, feature extraction on the one or more first image samples, to obtain the first plurality of sample features, and
wherein the object recognition model updating method further comprises:
performing feature extraction on the one or more first image samples through the feature extraction layer updated by using the model parameter, to obtain a third plurality of sample features of the one or more first image samples;
determining a fourth category center parameter of the third object recognition model based on the third plurality of sample features in the one or more first training sample sets; and
updating the third category center parameter to the fourth category center parameter.

5. The object recognition model updating method according to claim 2, wherein the one or more first image samples comprises a first plurality of image samples, and
wherein the determining the first category center parameter comprises:
determining a third plurality of sample features corresponding to the first plurality of objects in the one or more first training sample sets;
clustering the third plurality of sample features based on a first target quantity of cluster centers, to obtain a second target quantity of sample feature clusters; and
generating the first category center parameter based on target sample features corresponding to the cluster centers.

6. The object recognition model updating method according to claim 2, wherein the first category center parameter comprises a plurality of subcategory center parameters, and the plurality of subcategory center parameters are in a one-to-one correspondence with a first plurality of category centers of the first plurality of categories, and
wherein the performing the object recognition comprises:
performing feature extraction on the one or more first image samples to obtain the first plurality of sample features;
performing first object recognition on the first plurality of sample features in the one or more first training sample sets based on the plurality of subcategory center parameters, to obtain probabilities that objects in the one or more first image samples belong to the first plurality of category centers; and
determining, for the one or more first image samples and based on the probabilities that the objects in the one or more first image samples belong to the first plurality of category centers, categories to which the objects in the one or more first image samples belong, and using the categories to which the objects in the one or more first image samples belong as the plurality of recognition results.

7. The object recognition model updating method according to claim 6, wherein the performing the feature extraction comprises:
performing convolution processing on the one or more first image samples in the one or more first training sample sets, to obtain one or more convolution features of the one or more first image samples;
performing pooling on the one or more convolution features to obtain one or more pooling features of the one or more first image samples;
performing embedding feature extraction on the one or more pooling features to obtain one or more embedding features of the one or more first image samples;
performing feature mapping on the one or more embedding features to obtain one or more mapping features of the one or more first image samples; and
performing normalization on the one or more pooling features to obtain the first plurality of sample features.

8. The object recognition model updating method according to claim 1, wherein M is a number of the one or more first object recognition tasks, and the obtaining the first object recognition model comprises:
obtaining a third object recognition model;
obtaining the one or more first training sample sets;
training the third object recognition model based on a training sample set of an object recognition task of the one or more first object recognition tasks, to obtain an intermediate object recognition model of the object recognition task;
training an (i−1)^{th} intermediate object recognition model of an (i−1)^{th} object recognition task of the one or more first object recognition tasks based on an i^{th} training sample set of an i^{th} object recognition task of the one or more first object recognition tasks, to obtain an i^{th} intermediate object recognition model of the i^{th} object recognition task; and
traversing i object recognition tasks to obtain an M^{th} intermediate object recognition model of an M^{th} object recognition task, and using the M^{th} intermediate object recognition model as the first object recognition model, and
wherein M and i are integers greater than 1, and i is less than or equal to M.

9. The object recognition model updating method according to claim 1, wherein the one or more first image samples comprise a first plurality of image samples, and the one or more second image samples comprise a second plurality of image samples, and
wherein the determining the second category center parameter comprises:
determining a third plurality of sample features corresponding to the first plurality of objects from the first plurality of sample features;
determining a fourth plurality of sample features corresponding to the second plurality of objects from the second plurality of sample features;
clustering the third plurality of sample features and the fourth plurality of sample features based on a first target quantity of cluster centers, to obtain a second target quantity of sample feature clusters; and
generating the second category center parameter based on target sample features corresponding to the cluster centers.

10. The object recognition model updating method according to claim 1, wherein the determining the second category center parameter comprises:
performing, for the one or more first training sample sets:
determining, for the first plurality of sample features, feature similarities between the first plurality of sample features and the second plurality of sample features; and
screening, from a training sample set of the one or more first training sample sets, one or more third sample features of one or more third image samples of the training sample set with a feature similarity satisfying a similarity condition, to obtain one or more third training sample sets; and
determining the second category center parameter based on the one or more third sample features and the second plurality of sample features.

11. An object recognition model updating apparatus, comprising:
at least one memory configured to store computer program code; and
at least one processor configured to read the program code and operate as instructed by the program code, the program code comprising:
first obtaining code configured to cause at least one of the at least one processor to obtain a first object recognition model through training based on one or more first training sample sets of one or more first object recognition tasks, wherein the one or more first training sample sets comprise one or more first image samples of a first plurality of objects of a first plurality of categories in the one or more first object recognition tasks;
second obtaining code configured to configured to cause at least one of the at least one processor to determine a first category center parameter of the first object recognition model based on a first plurality of sample features of the one or more first image samples;
third obtaining code configured to configured to cause at least one of the at least one processor to obtain a second training sample set of a second object recognition task comprising one or more second image samples of a second plurality of objects of a second plurality of categories in the second object recognition task;
first determining code configured to configured to cause at least one of the at least one processor to determine a second category center parameter based on the first plurality of sample features and a second plurality of sample features of the one or more second image samples; and
first updating code configured to configured to cause at least one of the at least one processor to update the first category center parameter to the second category center parameter, to obtain a second object recognition model,
wherein the second object recognition model is configured to recognize, based on the second category center parameter, a second category to which a third object to be recognized belongs, and
wherein the second category comprises one from among the second plurality of categories and the first plurality of categories.

12. The object recognition model updating apparatus according to claim 11, wherein the first obtaining code comprises:
fourth obtaining code configured to cause at least one of the at least one processor to obtain a third object recognition model;
fifth obtaining code configured to cause at least one of the at least one processor to obtain the one or more first training sample sets, wherein the one or more first image samples are annotated with labels;
sixth obtaining code configured to cause at least one of the at least one processor to obtain the first plurality of sample features;
second determining code configured to cause at least one of the at least one processor to determine a third category center parameter of the third object recognition model based on the first plurality of sample features;
first performing code configured to cause at least one of the at least one processor to perform, through the third object recognition model, object recognition on the one or more first image samples based on the third category center parameter, to obtain a plurality of recognition results for the one or more first image samples; and
second updating code configured to cause at least one of the at least one processor to update a model parameter of the third object recognition model based on a difference between the labels and the plurality of recognition results, to obtain the first object recognition model, wherein the model parameter is different from the third category center parameter.

13. The object recognition model updating apparatus according to claim 12, wherein the fifth obtaining code is configured to cause at least one of the at least one processor to:
obtain an object video of an object recognition task of the one or more first object recognition tasks comprising a first plurality of frames of video images;
determine a second plurality of frames of target video images in the first plurality of frames comprising a third plurality of objects of a third plurality of categories in the object recognition task;
select, for the third plurality of objects, a target quantity of first video images comprising the third plurality of objects from the second plurality of frames;
use the first video images as the one or more first image samples; and
construct the one or more first training sample sets based on the one or more first image samples.

14. The object recognition model updating apparatus according to claim 12, wherein the third object recognition model comprises a feature extraction layer,
wherein the obtaining the sixth obtaining code is configured to cause at least one of the at least one processor to:
perform, through the feature extraction layer, feature extraction on the one or more first image samples, to obtain the first plurality of sample features, and
wherein the program code further comprises:
second performing code configured to cause at least one of the at least one processor to perform feature extraction on the one or more first image samples through the feature extraction layer updated by using the model parameter, to obtain a third plurality of sample features of the one or more first image samples;
third determining code configured to cause at least one of the at least one processor to determine a fourth category center parameter of the third object recognition model based on the third plurality of sample features in the one or more first training sample sets; and
third updating code configured to cause at least one of the at least one processor to update the third category center parameter to the fourth category center parameter.

15. The object recognition model updating apparatus according to claim 12, wherein the one or more first image samples comprises a first plurality of image samples, and
wherein the second obtaining code is configured to cause at least one of the at least one processor to:
determine a third plurality of sample features corresponding to the first plurality of objects in the one or more first training sample sets;
cluster the third plurality of sample features based on a first target quantity of cluster centers, to obtain a second target quantity of sample feature clusters; and
generate the first category center parameter based on target sample features corresponding to the cluster centers.

16. The object recognition model updating apparatus according to claim 12, wherein the first category center parameter comprises a plurality of subcategory center parameters, and the plurality of subcategory center parameters are in a one-to-one correspondence with a first plurality of category centers of the first plurality of categories, and
wherein the first performing code comprises:
second performing code configured to cause at least one of the at least one processor to perform feature extraction on the one or more first image samples to obtain the first plurality of sample features;
third performing code configured to cause at least one of the at least one processor to perform first object recognition on the first plurality of sample features in the one or more first training sample sets based on the plurality of subcategory center parameters, to obtain probabilities that objects in the one or more first image samples belong to the first plurality of category centers; and
third determining code configured to cause at least one of the at least one processor to determine, for the one or more first image samples and based on the probabilities that the objects in the one or more first image samples belong to the first plurality of category centers, categories to which the objects in the one or more first image samples belong, and using the categories to which the objects in the one or more first image samples belong as the plurality of recognition results.

17. The object recognition model updating apparatus according to claim 16, wherein the second performing code is configured to cause at least one of the at least one processor to:
perform convolution processing on the one or more first image samples in the one or more first training sample sets, to obtain one or more convolution features of the one or more first image samples;
perform pooling on the one or more convolution features to obtain one or more pooling features of the one or more first image samples;
perform embedding feature extraction on the one or more pooling features to obtain one or more embedding features of the one or more first image samples;
perform feature mapping on the one or more embedding features to obtain one or more mapping features of the one or more first image samples; and
perform normalization on the one or more pooling features to obtain the first plurality of sample features.

18. The object recognition model updating apparatus according to claim 11, wherein M is a number of the one or more first object recognition tasks, and the first obtaining code is configured to cause at least one of the at least one processor to:
obtain a third object recognition model;
obtain the one or more first training sample sets;
train the third object recognition model based on a training sample set of an object recognition task of the one or more first object recognition tasks, to obtain an intermediate object recognition model of the object recognition task;
train an (i−1)^{th} intermediate object recognition model of an (i−1)^{th} object recognition task of the one or more first object recognition tasks based on an i^{th} training sample set of an i^{th} object recognition task of the one or more first object recognition tasks, to obtain an i^{th} intermediate object recognition model of the i^{th} object recognition task; and
traverse i object recognition tasks to obtain an M^{th} intermediate object recognition model of an M^{th} object recognition task, and using the M^{th} intermediate object recognition model as the first object recognition model, and
wherein M and i are integers greater than 1, and i is less than or equal to M.

19. The object recognition model updating apparatus according to claim 11, wherein the one or more first image samples comprise a first plurality of image samples, and the one or more second image samples comprise a second plurality of image samples, and
wherein the first determining code is configured to cause at least one of the at least one processor to:
determine a third plurality of sample features corresponding to the first plurality of objects from the first plurality of sample features;
determine a fourth plurality of sample features corresponding to the second plurality of objects from the second plurality of sample features;
cluster the third plurality of sample features and the fourth plurality of sample features based on a first target quantity of cluster centers, to obtain a second target quantity of sample feature clusters; and
generate the second category center parameter based on target sample features corresponding to the cluster centers.

20. A non-transitory computer-readable storage medium, storing computer code which, when executed by at least one processor, causes the at least one processor to at least:
first obtaining code configured to cause at least one of the at least one processor to obtain a first object recognition model through training based on one or more first training sample sets of one or more first object recognition tasks, wherein the one or more first training sample sets comprise one or more first image samples of a first plurality of objects of a first plurality of categories in the one or more first object recognition tasks;
obtain a first category center parameter of the first object recognition model based on a first plurality of sample features of the one or more first image samples;
obtain a second training sample set of a second object recognition task comprising one or more second image samples of a second plurality of objects of a second plurality of categories in the second object recognition task;
determine a second category center parameter based on the first plurality of sample features and a second plurality of sample features of the one or more second image samples; and
update the first category center parameter to the second category center parameter, to obtain a second object recognition model,
wherein the second object recognition model is configured to recognize, based on the second category center parameter, a second category to which a third object to be recognized belongs, and
wherein the second category comprises one from among the second plurality of categories and the first plurality of categories.
